(19) United States
(12) Patent Application Publication
(10) Pub. No.: US 2026/0003027 A1
(43) Pub. Date: Jan. 1, 2026

(54) MULTI-FREQUENCY OPERATION FOR AOA WITH ANTENNA SEPARATION GREATER THAN HALF OF WAVELENGTH

(71) Applicant: QUALCOMM Incorporated, San Diego, CA (US)

(72) Inventor: Feliciano GOMEZ MARTINEZ, Los Gatos, CA (US)

(21) Appl. No.: 18/761,188

(22) Filed: Jul. 1, 2024

(51) Int. Cl. G01S 5/02; G01S 3/46; H04W 64/00

(52) U.S. Cl. CPC G01S 5/0289; G01S 3/46; H04W 64/003

(57) ABSTRACT

Aspects presented herein may enable a first UE to estimate the angle-of-arrival (AoA) of a second UE. In one aspect, a first UE measures a set of phase difference of arrivals (PDoAs) for a set of radio links between the first UE and a second UE, each radio link in the set of radio links is associated with a different wavelength. The first UE determines a general function that is associated with a probability in which the second UE is at a set of relative directions or a set of relative positions compared to the first UE. The first UE estimates a relative direction or a relative position of the second UE compared to the first UE, where the relative direction is included in the set of relative directions and the relative position is included in the set of relative positions.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning (e.g., including tracking and/or ranging) protocols and techniques that enable mobile network operators to provide high-accuracy location/tracking/ranging services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus measures a set of phase difference of arrivals (PDoAs) for a set of radio links between the first user equipment (UE) and a second UE, where each radio link in the set of radio links is associated with a wavelength that is different from another radio link in the set of radio links, where the first UE includes at least two antennas with an antenna separation distance that is greater than or equal to a threshold. The apparatus determines, based on the set of PDoAs for the set of radio links, a general function that is associated with a probability in which the second UE is at a set of relative directions or a set of relative positions compared to the first UE. The apparatus estimates, based on the determined general function, a relative direction or a relative position of the second UE compared to the first UE, where the relative direction is included in the set of relative directions and the relative position is included in the set of relative positions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5 is a diagram illustrating an example of tracking in accordance with various aspects of the present disclosure.

FIG. 6 is a diagram illustrating an example of a tracking device moving through space while measuring time of flight (ToF) distance and angle-of-arrival (AoA)/phase difference of arrival (PDoA) of a target device in accordance with various aspects of the present disclosure.

FIG. 7 is a diagram illustrating an example procedure for round-trip time (RTT)/ToF estimation between two wireless devices in accordance with various aspects of the present disclosure.

FIG. 8 is a diagram illustrating example scenarios in which a static wireless device may demand estimating the relative direction of another wireless device using radio signals in accordance with various aspects of the present disclosure.

FIG. 9A is a diagram illustrating an example geometric configuration for angle-of-arrival (AoA) estimation using phase difference of arrival (PDoA) in accordance with various aspects of the present disclosure.

FIG. 9B is a diagram illustrating an example ideal curve for PDoA as a function of AoA in accordance with various aspects of the present disclosure.

FIG. 10A is a diagram illustrating an example relationship between AoA and PDoA for different antenna separation distances in accordance with various aspects of the present disclosure.

FIG. 10B is a diagram illustrating an example relationship between AoA and PDoA for different antenna separation distances in accordance with various aspects of the present disclosure.

FIG. 10C is a diagram illustrating an example relationship between AoA and PDoA for different antenna separation distances in accordance with various aspects of the present disclosure.

FIG. 11 is a diagram illustrating an example of a tracking device being unable to distinguish between multiple candidate AoA values in accordance with various aspects of the present disclosure.

FIG. 12 is a diagram illustrating an example of a tracking device distinguishing between multiple candidate AoA values based on performing ranging/AoA estimations using multiple frequencies in accordance with various aspects of the present disclosure.

FIG. 13 is a diagram illustrating examples of PDoA functions with different frequencies in accordance with various aspects of the present disclosure.

FIG. 14 is a diagram illustrating an example of AoA candidates when measuring PDoA using 2.4 GHz frequency in accordance with various aspects of the present disclosure.

FIG. 15 is a diagram illustrating an example of AoA candidates when measuring PDoA using 5 GHz frequency in accordance with various aspects of the present disclosure.

FIG. 16 is a diagram illustrating an example of AoA candidates when measuring PDoA using 6 GHz frequency in accordance with various aspects of the present disclosure.

FIG. 17 is a diagram illustrating an example of finding the true AoA from multiple AoA candidates using multiple frequencies in accordance with various aspects of the present disclosure.

FIG. 18 is a diagram illustrating an example of building a loss function that is capable of finding the true AoA in accordance with various aspects of the present disclosure.

FIG. 19 is a communication flow illustrating an example algorithm of a tracking device determining the AoA of a target device using multiple frequencies in accordance with various aspects of the present disclosure.

FIG. 20 is a flowchart of a method of wireless communication.

FIG. 21 is a flowchart of a method of wireless communication.

FIG. 22 is a diagram illustrating an example of a hardware implementation for an example apparatus and/or network entity.

### DETAILED DESCRIPTION

Various aspects relate generally to wireless communication and more particularly to tracking and/or ranging based on wireless communication. Some aspects more specifically relate to improving the overall performance of wireless tracking and ranging by enabling a static tracking device to locate a static target device based on using multiple frequencies for the angle-of-arrival (AoA) estimation, where the static tracking device may have an antenna separation distance greater than half of the communication wavelength (e.g., antenna separation distance (L)>wavelength (λ)/2). For example, in one aspect of the present disclosure, a tracking device may be configured to measure the phase difference of arrival (PDoA) for signals transmitted from a target device using multiple frequencies such that each frequency may produce multiple AoA candidates. Then, the tracking device may determine a true AoA from the multiple AoA candidates based on finding a common AoA candidate for each frequency, which may be identified by building and optimizing a loss function. In an embodiment, PDOA may be measured using multiple frequencies such that each frequency produces multiple AoA candidates; the true AoA candidate may be the one that is a common candidate for each frequency and may be identified by building and optimizing a loss function.

Particular aspects of the subject matter described in this disclosure can be implemented to realize one or more of the following potential advantages. Aspects presented herein may bring significant benefits to devices that cannot be easily moved during operation, such as computers, televisions (TVs), industrial equipments, etc., by enabling them to locate other devices without moving. For example, certain positioning/tracking mechanisms/algorithms may specify at least one of the tracking device or the target device to be moving in order for the tracking device to obtain a direction/distance estimation of the target device. However, in some scenarios, when the tracking device and/or the target device are large in size, heavy, or stationary, they may not be able to be easily moved. Also, if a fixed device (for example, a TV) wants to use AoA techniques to detect the relative position of some other device, then the antennas of the fixed device may be specified to be close to each other to ensure their separation meets

$$L < \frac{λ}{2} .$$

This may be unsuitable for wireless communication performance, because this may reduce the diversity obtained from multiple antennas (e.g., if one antenna is blocked due to a person standing in front of it, then other antennas are also likely to be blocked). However, aspects presented herein may enable manufacturers of wireless devices to configure/put AoA antennas farther apart from each other, ensuring they provide good diversity when used for communication, and are still capable of being used for the AoA estimation. Aspects presented herein rely on using multiple frequencies when exchanging radio frequency (RF) signals for AoA estimation (either simultaneously or in rapid succession), in cases in which antenna separation is larger than λ/2. The tracking device may be specified to request the target device to send RF signals over two or more frequencies, because for L>λ/2 each PDoA measurement (ψᵢ) may map to multiple AoA candidate values/angles {θᵢ₁, . . . , θᵢₖ}. However, as one specific value of θ can be found in all the sets of AoA candidates, the tracking device may detect that specific value as the true AoA value/angle. While aspects presented herein may remove the specification for the tracking device to move/rotate to remove ambiguity, aspects presented herein also support cases in which the tracking device is moving/moved.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

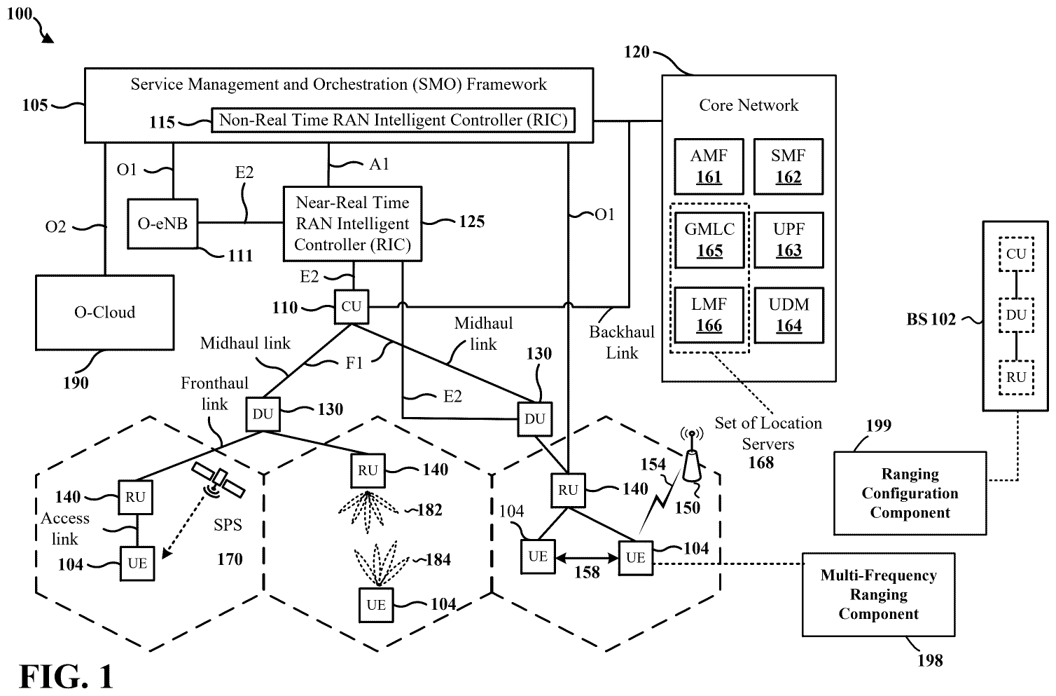

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a multi-frequency ranging component 198 that may be configured to measure a set of phase difference of arrivals (PDoAs) for a set of radio links between the first UE and a second UE, where each radio link in the set of radio links is associated with a wavelength that is different from another radio link in the set of radio links, where the first UE includes at least two antennas with an antenna separation distance that is greater than or equal to a threshold; determine, based on the set of PDoAs for the set of radio links, a general function that is associated with a probability in which the second UE is at a set of relative directions or a set of relative positions compared to the first UE; and estimate, based on the determined general function, a relative direction or a relative position of the second UE compared to the first UE, where the relative direction is included in the set of relative directions and the relative position is included in the set of relative positions. In certain aspects, the base station 102 may have a ranging configuration component 199 that may be configured to provide configurations and/or parameters related to tracking/ranging for the UE 104.

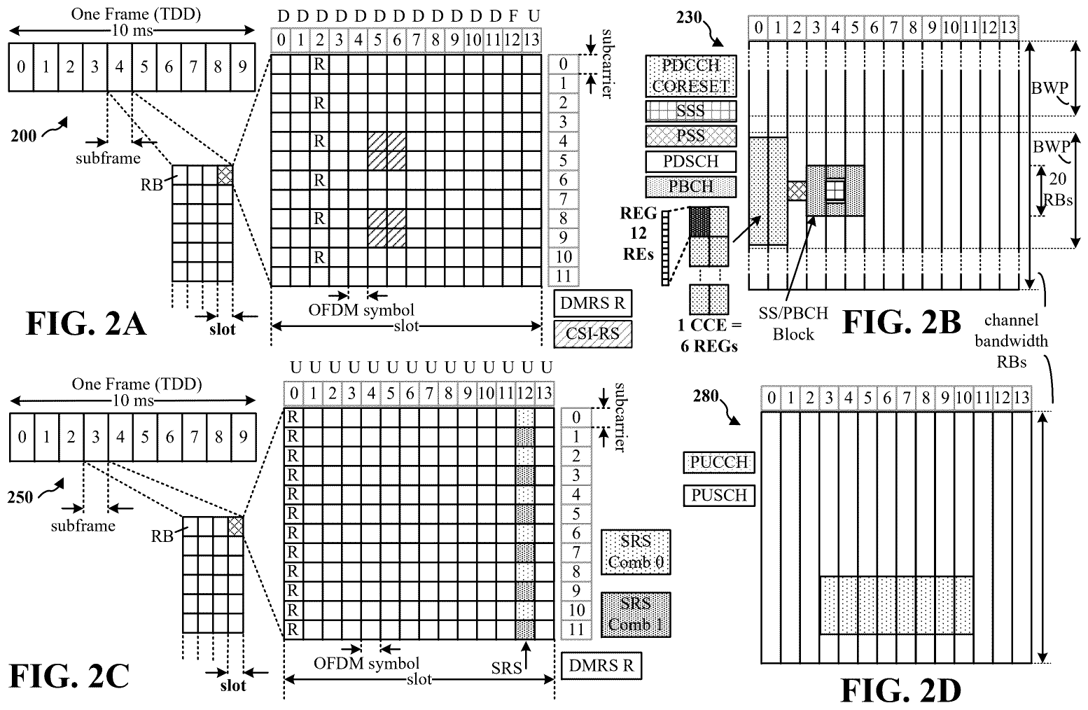

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

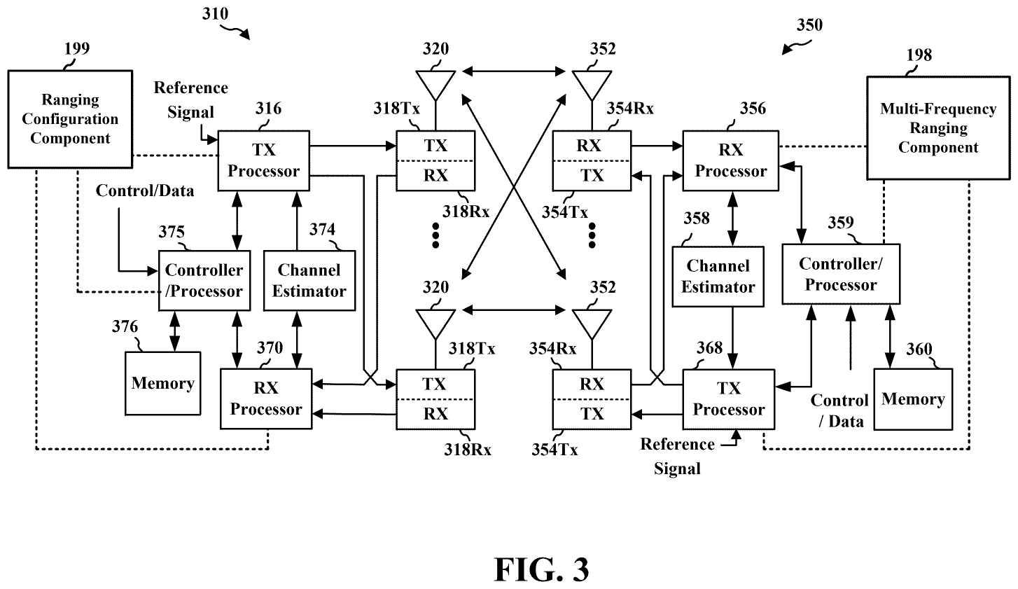

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-frequency ranging component 198 of FIG. 1.

At least one of the TX processor 316, the RX processor 370, and the controller/processor 375 may be configured to perform aspects in connection with the ranging configuration component 199 of FIG. 1.

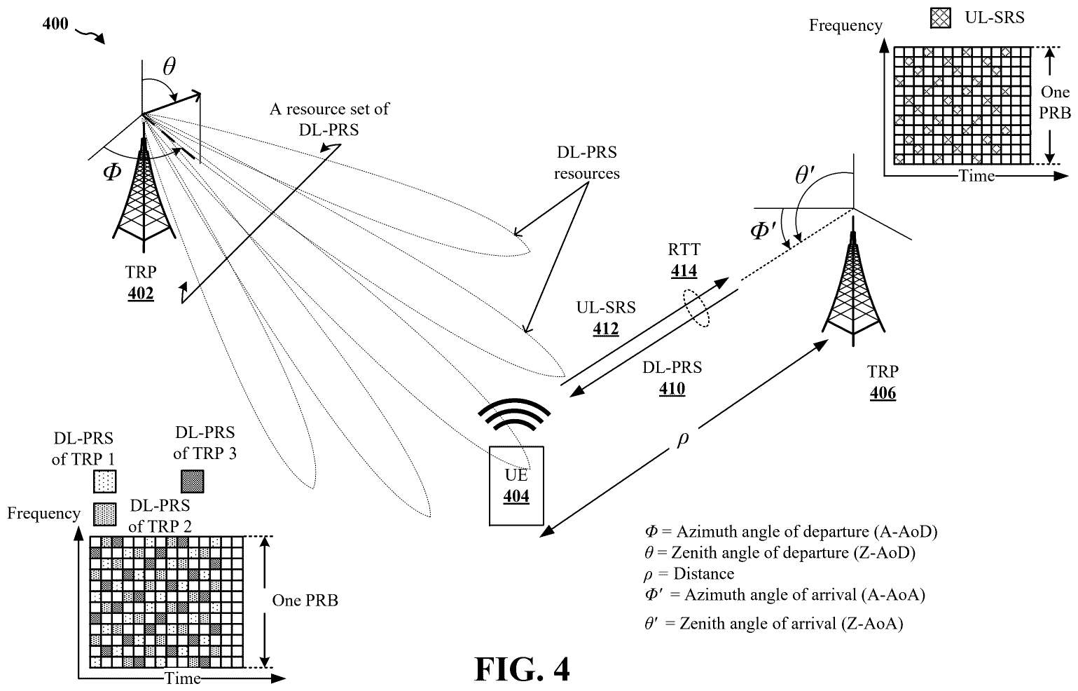

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS)(DL PRS) 410 at time T_{PRS_RX}. The TRP 406 may receive the UL SRS 412 at time T_{SRS_RX} and transmit the DL PRS 410 at time TPRS TX. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx−Tx time difference measurements (i.e., |T_{SRS_TX}−T_{PRS_RX}|) and DL PRS reference signal received power (RSRP)(DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FRI, the reference point for the DL PRS-RSRP may be the antenna connector of the UE. For FR2, DL PRS-RSRP may be measured based on the combined signal from antenna elements corresponding to a given receiver branch. For FRI and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle-of-arrival (A-AoA) and zenith angle-of-arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to the network-based positioning described in connection with FIG. 4, various positioning methods/mechanisms have also been developed for localizing or tracking the position of a target. These positioning methods/mechanisms may be classified into active positioning (which may also be referred to and used interchangeably with “active localization”) and passive positioning (which may also be referred to and used interchangeably with “passive localization”). For active positioning, a wireless device may locate a target based on signals transmitted from the target. For example, the target may be attached or configured with a radio frequency (RF)-capable device/component, such as a tag (e.g., an RF tag), a Global Positioning System (GPS)/wireless tracker, a device/component capable of transmitting/receiving positioning reference signals, a device/component capable of performing or responding to ranging/radar operations, etc. Then, based on signals transmitted from the target (or from the RF-capable device/component attached to the target), the wireless device may calculate or estimate the location of the target. On the other hand, for passive positioning, a target may be localized and tracked without attaching an RF-capable device/component to the target. For example, RF radars, light detection and ranging (Lidars), sonars, and/or cameras are example technologies/components that may be used by a wireless device for passive positioning, where the wireless device may locate a target based on images or based on reflection of signals, etc.

A wireless device may be able to locate and track another wireless device based on using one or more tracking/ranging technologies. For purposes of the present disclosure, tracking technologies may refer to methods and systems that are used for estimating, monitoring, and/or following the movements/locations of a target (e.g., an object, a person, an animal, a vehicle, etc.) over time. Tracking technologies may have different applications across various industries, and may use different principles and devices to achieve the tracking. Depending on implementations, some tracking technologies may be based on ranging operations, which may be referred to as ranging technologies. A ranging operation/technology may refer to a method/technique that is used to measure the distance between two points or objects. An example of ranging operation/technology may include a user locating a target device (e.g., a Bluetooth® device such as a pair of earbuds) using a mobile device (e.g., a smartphone), where the mobile device may continue to estimate the distance and/or location of the target device based on signals from the target device. Depending on the context, in some examples, the term “track/tracking” may be used interchangeably with the term “position/positioning” or “location/locationing.” For example, a wireless device may be configured to track a target based on estimating the position/location of the target using Wi-Fi technologies, which may be referred to as Wi-Fi tracking or Wi-Fi positioning/locationing. Similarly, depending on the context, in some examples, the term “tracking” may be used interchangeably with the term “ranging.” For example, a wireless device may be configured to track a target based on performing ranging against the target using UWB technologies, which may be referred to as UWB/UWB-based tracking or ranging.

The tracking technologies may be used in various fields such as surveying, navigation, robotics, telecommunications, etc. Examples of tracking technologies may include:
(1) global navigation satellite system (GNSS)/global positioning system (GPS) tracking—GNSS/GPS tracking relies on a network of satellites to provide real-time location information. GNSS/GPS receivers, often embedded in devices like smartphones, vehicles, or wearables, may determine their precise location and movement.
(2) radio-frequency identification (RFID) tracking—RFID technology uses radio waves to identify and track objects equipped with RFID tags, where these RFID tags may include electronic information that can be read by RFID readers, enabling the tracking of items in logistics, inventory management, and access control.
(3) Bluetooth® (BT) tracking—Bluetooth technology may be used for tracking by measuring the signal strength between devices. Bluetooth channel sounding (CS) (BTCS) is another technique that may also be used for tracking by measuring the round-trip-time (RTT)/the phase delay of RF signals between devices. Bluetooth beacons or tags may be attached to objects or carried by individuals, and their proximity to Bluetooth receivers may be used to estimate their location.
(4) Wi-Fi® tracking—Wi-Fi tracking may involve using signals from Wi-Fi access points (APs) to estimate the location of target devices. This tracking method is often suitable for indoor environments, such as malls and airports, for tracking people or assets.
(5) cellular tracking—mobile network infrastructure may be able to track devices through the triangulation of cell tower signals. The approximate location of a mobile device can be determined by analyzing the signals it receives from nearby cell towers.
(6) inertial navigation systems—these systems may use accelerometers and gyroscopes to track changes in velocity and orientation.
(7) computer vision tracking—advanced computer vision technologies, including object recognition and tracking algorithms, may enable cameras and sensors to track the movement of objects or people based on visual data.
(8) ultra-wideband (UWB) tracking—UWB tracking may utilize signals with very high frequency ranges or bandwidths. UWB technology transmits data using a broad spectrum of frequencies, enabling precise and accurate tracking of objects or individuals in both indoor and outdoor environments. UWB tracking systems typically operate in the frequency range of 3.1 to 10.6 gigahertz.

As discussed above, ranging operations/technologies may refer to methods/techniques that is used to measure the distance between two points or objects. Examples of ranging operations/technologies may include:
(1) triangulation—triangulation involves measuring the angles between an observer and two known points or landmarks. By using trigonometry, the distance to the object may be calculated or estimated.
(2) time of flight (ToF)—ToF technology measures the time taken for a signal (such as light or sound) to travel from a transmitter to a target and back to a receiver. By knowing the speed of the signal, usually the speed of light or sound, the distance may be calculated or estimated.
(3) GNSS—GNSS systems, such as GPS, global navigation satellite system (GLONASS), Galileo, and BeiDou, use signals from satellites to determine the position of a receiver on Earth. By analyzing the amount of time it takes for signals from multiple satellites to reach the receiver, its position (including distance) may be calculated or estimated.
(4) RFID—RFID technology uses electromagnetic fields to automatically identify and track tags attached to objects. The distance between the reader and the RFID tag may be estimated based on the strength of the received signal.
(5) ultrasonic ranging—ultrasonic ranging involves emitting ultrasonic pulses and measuring the time it takes for the pulses to bounce back from the object. The speed of sound in the medium determines the distance.
(6) laser ranging (e.g., light detection and ranging (Lidar))—laser ranging uses lasers to measure the distance to a target by calculating the time it takes for laser pulses to travel to the target and back.

Among the aforementioned tracking/ranging technologies, UWB, Bluetooth, and/or Wi-Fi based tracking/ranging have continued to be widely used and developed for most wireless devices (e.g., consumer devices such as mobile phones, smart watches, etc.) due to their accessibility and tracking/ranging precisions.

UWB tracking/ranging may refer to using a UWB device/technology to locate and track objects, people, or assets within a certain range. A UWB device (e.g., a device that is capable of performing UWB tracking/ranging) may use pulse-based radio signaling (e.g., Short-pulse-UWB) instead of orthogonal frequency division multiplexing (OFDM)-based signaling (e.g., Multi-Band (MB)-OFDM-UWB (MB-OFDM-UWB)). Short-pulse-UWB signaling may transmit with the energy for each bit spread over the entire UWB channel bandwidth (e.g., 1.37 GHZ, 4 GHZ, etc.) with varying pulse amplitude and/or pulse polarity without using a RF carrier while MB-OFDM-UWB may transmit each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g., Gaussian pulses, Monocycle pulses, Hermite pulses, etc.) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle the need for ultra-fast sampling such as using Time Hopping techniques, Direct Sequence coding techniques, etc.

MB-OFDM-UWB may divide up spectrum into several frequency sub-bands and OFDM is applied within each band; whereas, other OFDM systems may typically operate within a fixed frequency band. The complex waveform created by combining the multiple-sub-bands results in a final waveform that used for transmission for MB-OFDM-UWB. MB-OFDM-UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

Bluetooth tracking/ranging may refer to using Bluetooth device/technology to locate and track objects, people, or assets within a certain range. This technology may rely on Bluetooth-enabled devices, such as smartphones, tablets, or specialized Bluetooth tags, to communicate with each other and determine their relative positions.

Bluetooth tracking may include beacon-based tracking and Bluetooth low energy (LE) tracking. Beacon-based tracking may involve deploying Bluetooth beacons that emit Bluetooth signals at regular intervals. These signals are picked up by Bluetooth-enabled devices in the vicinity, such as smartphones or tablets. By measuring the signal strength and timing of these beacon signals, the receiving devices can estimate their proximity to the beacon. This information may then be used to determine the location of the Bluetooth-enabled device within the range of the beacon. Bluetooth LE tracking may enable devices to communicate over short distances while consuming minimal power. Bluetooth LE tracking systems may include attaching tags to objects or carried by individuals, and Bluetooth LE receivers (such as smartphones or dedicated receivers) that scan for these tags. The receivers detect the signals transmitted by the tags and use signal strength and other parameters to estimate the distance between the tag and the receiver. By triangulating signals from multiple receivers, the system can determine the location of the tagged object or person. Bluetooth channel sounding (CS) is a technique used in Bluetooth communication to measure time/phase delay of BT signals, such that distance between wireless devices may be estimated/measured more accurately.

Wi-Fi tracking/ranging may refer to using a Wi-Fi capable device/technology for monitoring and tracking the movement of devices within a Wi-Fi network's coverage area. Wi-Fi tracking may rely on the unique media access control (MAC) addresses of Wi-Fi-enabled devices, such as smartphones, tablets, and laptops, to identify and track them as they move within the network's range. For example, Wi-Fi tracking utilizes Wi-Fi access points (APs), which are devices that provide wireless network connectivity to devices within their range. These access points continuously broadcast Wi-Fi signals, allowing Wi-Fi-enabled devices to connect to the network. When Wi-Fi-enabled devices come within range of Wi-Fi access points, they may be configured to automatically send out probe requests, seeking available networks to connect to. Wi-Fi access points receive these probe requests and respond with probe responses containing information about the network, such as the service set identifier (SSID) and signal strength. Each Wi-Fi-enabled device may have a unique MAC address associated with its network interface. Wi-Fi tracking systems capture these MAC addresses from the probe requests and responses exchanged between devices and access points. By monitoring the signal strength and timestamps of probe requests and responses from multiple access points, Wi-Fi tracking systems may triangulate the position of Wi-Fi-enabled devices within the network's coverage area.

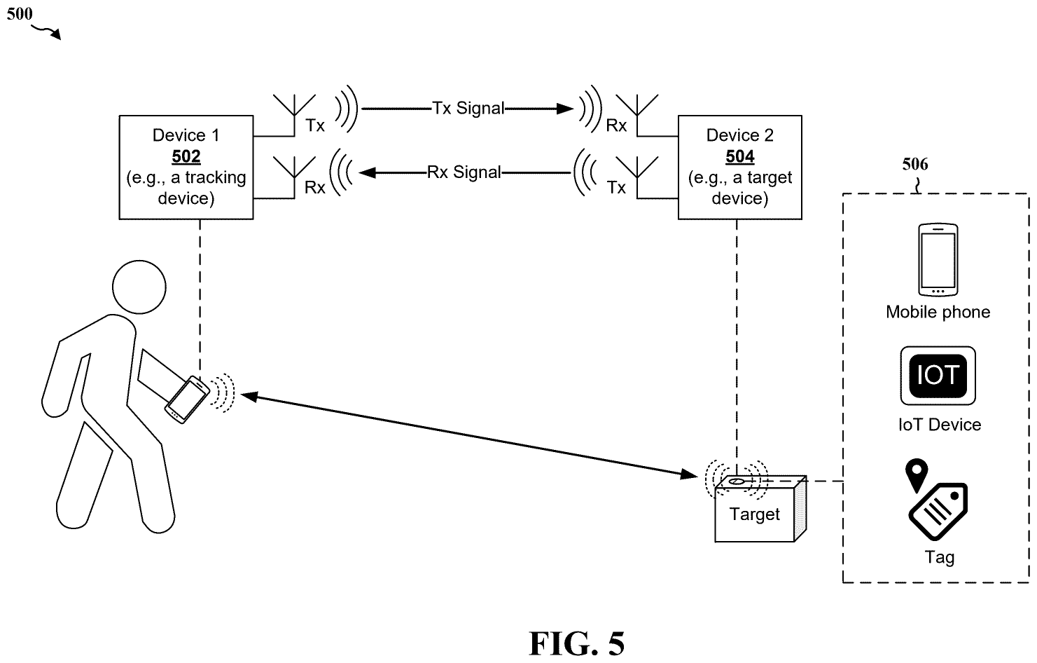

FIG. 5 is a diagram 500 illustrating an example of tracking (e.g., active positioning) in accordance with various aspects of the present disclosure. A first device 502 (which may also be referred to as a “tracking device” or a “finder device” for purposes of the present disclosure) may be able to locate a second device 504 (which may also be referred to as a “target” or a “target device” for purposes of the present disclosure) based on transmitting signals (which may be referred to as “transmission (Tx) signals”) to the second device 504, and receive signals (which may be referred to as “reception (Rx) signals”) from the second device 504. Depending on implementations, the Rx signals may be signals reflected from the second device 504 (e.g., based on the Tx signals) or signals generated by the second device 504. Then, based on the time-of-flight (ToF) of the Tx signals and the Rx signals, the first device 502 may estimate the distance of the second device 504 from the first device 502. In some configurations, if the first device is also capable of measuring the angle-of-arrival (AoA) of the Rx signals, the first device 502 may also be able to estimate the direction of the second device 504 from the first device 502 (which may be referred to as the relative direction from the first device 502). As shown at 506, the second device 504 may be a mobile phone, an Internet of Things (IoT) device, or a tag (e.g., an RFID tag), and the localizing and/or tracking of the second device 504 may be based on using Bluetooth® tracking, Wi-Fi tracking, or UWB tracking, etc.

The tracking mechanisms discussed above may have a variety of applications in real life. For example, it is common for users to lose small items (e.g., earbuds, keys, wallets, etc.) somewhere in their home, at work, or in school, and users may often rely on using tracking devices (e.g., their mobile phones) to find those lost items (e.g., earbuds, smart tags, other phones) near them. In some scenarios, a tracking device may just have the capability to identify a rough location of a target device. For example, some tracking devices may be able to just estimate that an item (e.g., a target device) is at a rough location (e.g., at home, at a specific address, at a business, etc.) based on detecting the strength of wireless signals from the item. However, in some scenarios, it may not be enough for users to know that the item is at a rough location, and the users may want to the specific location of the item, such as in a specific room (e.g., in a restroom, bedroom, kitchen, etc.) or in a specific location (e.g., under the bed, on a coach, etc.). As such, accurate positioning/tracking of the target device can be very useful for users.

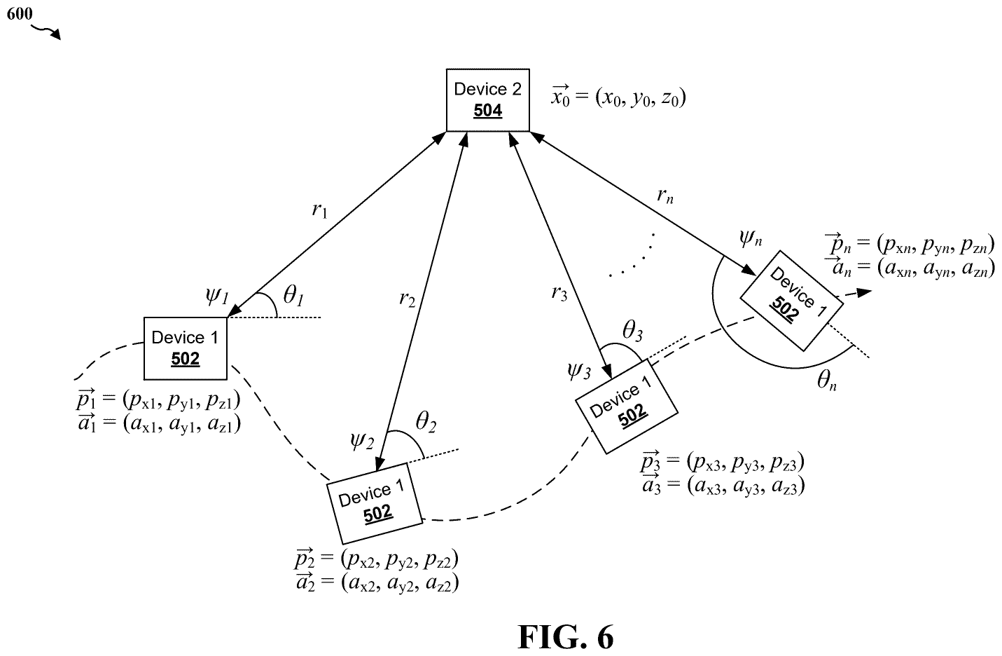

FIG. 6 is a diagram 600 illustrating an example of a tracking device moving through space while measuring time of flight (ToF) distance and angle-of-arrival (AoA)/phase difference of arrival (PDoA) of a target device in accordance with various aspects of the present disclosure. For purposes of the illustration, \vec{p}ₙ is the position of the tracking device at time tₙ, \vec{α}ₙ is the antenna vector at time tₙ, rₙ is the distance measured to the target device at time tₙ, θₙ is the spatial AoA relative to the antenna vector \vec{α}ᵢ, and ψₙ is the PDOA measured by the antenna vector \vec{α}ₙ.

In one example, the tracking device (e.g., the first device 502, a mobile phone, etc.) may be configured to perform multiple distance measurements rₙ and AoAs θₙ for the target device (e.g., the second device 504) from multiple positions \vec{p}ₙ of the tracking device based on ToF and PDoA ψₙ, respectively. For example, when the first device 502 (e.g., the tracking device) is at a first position \vec{p}₁, the first device 502 may measure a first distance r₁ between the first device 502 and the second device 504 (e.g., the target device) based on ToF, such as described in connection with FIG. 5. The first device 502 may also obtain a first AoA θ₁ between the first device 502 and the second device 504 based on measuring a first PDoA ψ₁. Similarly, when the first device 502 is at a second position \vec{p}₂, the first device 502 may measure a second distance r₂ between the first device 502 and the second device 504 based on ToF, and also obtain a second AoA θ₂ between the first device 502 and the second device 504 based on measuring a second PDoA ψ₂. The first device 502 may repeat this process at each of the of multiple positions \vec{p}ₙ. Then, based on multiple distance measurements (e.g., r₁ to rₙ) and AoAs (e.g., θ₁ to θₙ) at multiple positions (e.g., \vec{p}₁ to \vec{p}ₙ), the first device 502 may be able to determine/estimate the position of the second device 504, such as based on triangulation.

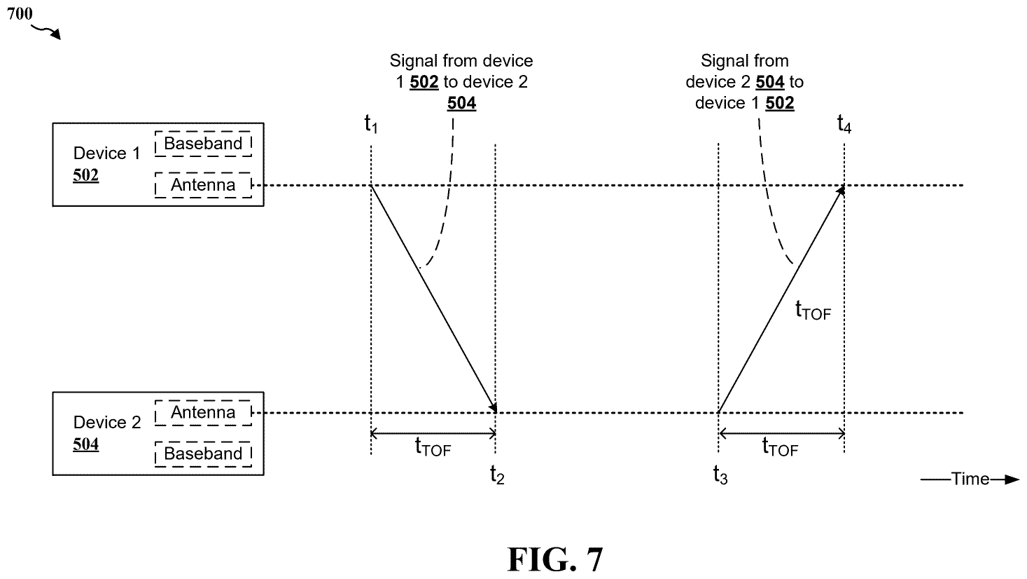

FIG. 7 is a diagram 700 illustrating an example procedure for round-trip time (RTT)/time-of-flight (ToF) estimation between two wireless devices in accordance with various aspects of the present disclosure. As discussed in connection with FIGS. 5 and 6, wireless tracking/ranging technologies (such as based on UWB, Wi-Fi, or BT, etc.) may rely on measuring the ToF of wireless signals sent between wireless devices. For example, an estimation of the ToF between the first device 502 and the second device 504 may be based on measuring the departure time and the arrival time for a wireless signal, then using the formula:

$${t}_{T O F} = \frac{( {t}_{4} - {t}_{1} ) - ( {t}_{3} - {t}_{2} )}{2}$$

Then the distance (d_{TOF}) between both devices may be estimated by multiplying the ToF by the speed of light (c):

$${d}_{T O F} = c \cdot {t}_{T O F}$$

This formula and calculation may represent an ideal case and work fine if the times t₁, t₂, t₃, t₄ are able to be accurately measured.

While the example tracking mechanism discussed in connection with FIG. 6 may enable a tracking device (e.g., the first device 502) to locate a target device (e.g., the second device 504) based on measuring the distances between them from multiple positions, in some scenarios, the tracking device may not be able to locate the target device if both devices are static (e.g., not moving). This may occur when the distance (L) between antennas (e.g., between a pair of antennas) of the tracking device is greater than half of the wavelength (λ) of the signal(s) used for the tracking/ranging (e.g., L>λ/2). For purposes of the present disclosure, the distance between antennas may be referred to as an “antenna separation distance” and/or an “antenna separation.”

For example, a tracking device may be able to locate a target device by measuring the AoA of signals transmitted from the target device using at least two (2) antennas. However, such mechanism may specify the distance (L) between the at least two antennas to be less than half of the wavelength (λ) of the signals (e.g., L<λ/2) (discussed below with examples). If the distance is greater than half of the wavelength, some conventional mechanisms/algorithms may not enable the tracking device to locate the target device, or the tracking device may be specified to move/rotate during tracking to mitigate the problem of antenna separation being L>λ/2.

Aspects presented herein may improve the overall performance of positioning/tracking between wireless devices (that may be static or moving slowly/below a speed threshold) by enabling the wireless devices to perform the positioning/tracking using multiple wavelengths. Aspects presented herein may enable a tracking device to locate a target device based on using multiple frequencies for the AoA estimation, such that the tracking device may have an antenna separation distance greater than half of the communication wavelength (e.g., antenna separation distance (L)>wavelength (λ)/2). For example, in one aspect of the present disclosure, a tracking device may be configured to measure the phase difference of arrival (PDoA) for signals transmitted from a target device using multiple frequencies such that each frequency may produce multiple AoA candidates. Then, the tracking device may determine a true AoA from the multiple AoA candidates based on finding a common AoA candidate for each frequency, which may be identified by building and optimizing a loss function. Aspects presented herein may be beneficial to devices that cannot be easily moved during operation, such as computers, televisions (TVs), industrial equipments, etc., to locate other devices without moving. For purposes of the present disclosure, a “true AoA” or “true AoA value/angle” may refer to an AoA or AoA value/angle that corresponds to the actual location of a target device (with respect to the tracking device). In general, when there are multiple candidate AoA values (for a PDoA function/measurement), just one of the multiple candidate AoA values is the true AoA.

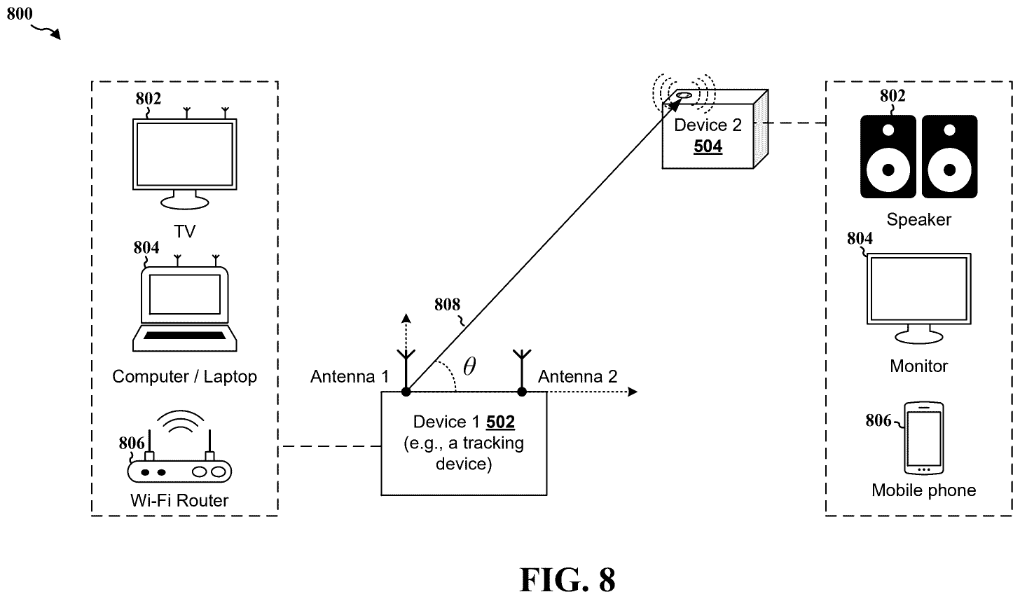

FIG. 8 is a diagram 800 illustrating example scenarios in which a wireless device may demand estimating the relative direction of another wireless device using radio signals in accordance with various aspects of the present disclosure. In one example, as shown at 802, a TV or an audio/video (AV) receiver may want to determine the relative position (e.g., the AoA (θ)) of a speaker to enable the TV/AV receiver to configure the speaker as the left/right/center speaker. In another example, as shown at 804, a desktop computer or laptop may want to determine the relative position of an external monitor or tablet so that the operating system of the desktop computer/laptop may extend the screen to the right direction (e.g., for setting up dual monitors). In another example as shown at 806, a Wi-Fi router may want to estimate the relative location of a Wi-Fi client device (e.g., a mobile phone). These example scenarios may be summarized as a wireless/tracking device trying to determine the direction towards a target device.

As shown at 808, a wireless/tracking device (e.g., the first device 502), which may be static or moving slowly, may be able to wirelessly determine the relative direction/position of a target device (e.g., the second device 504) based on estimating the AoA of the signal transmitted by the target device using at least a pair of antennas (e.g., using a minimum of two antennas). For example, the wireless/tracking device may measure the phase difference of arrival (PDoA) of the signal from the target device as there is a defined/known mathematical relationship between the AoA (denoted by the variable θ) and the PDoA (denoted by the variable ψ), where the wireless/tracking device may measure the PDoA (ψ) of the signal and then invert the relationship to obtain θ. In other words, the AoA may be a variable of the PDoA function.

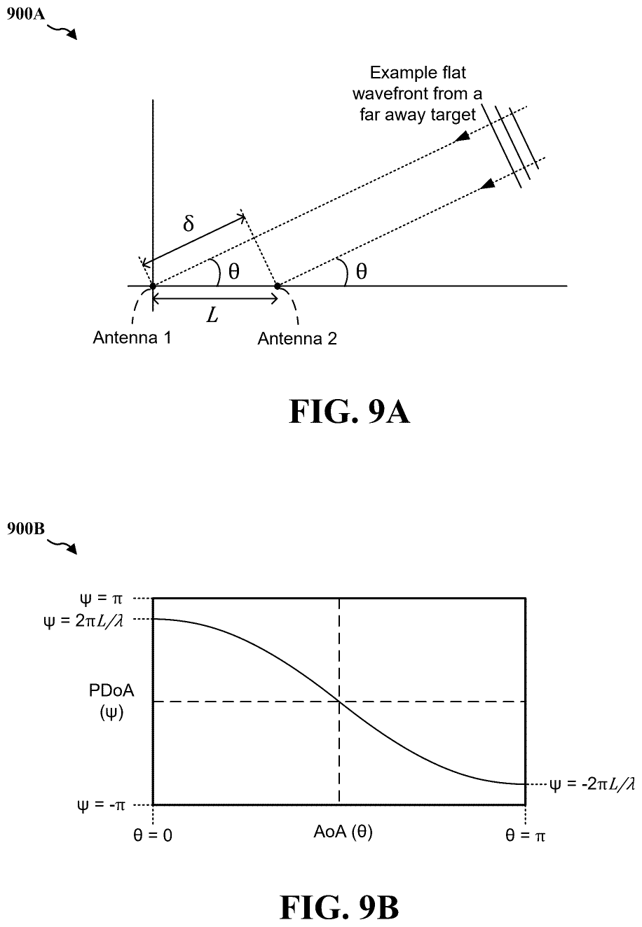

FIG. 9A is a diagram 900A illustrating an example geometric configuration for AoA estimation using PDoA in accordance with various aspects of the present disclosure. In general, for a wireless/tracking device, which may be static or moving slowly, to compute the AoA of the signal from a target device, the wireless/tracking device may be specified to meeting at least two criteria: (1) each pair of antennas has an antenna separation (L) that meets the condition (L<λ/2), λ being the wavelength of the signal, and (2) the PDoA function (ψ) for each pair of antennas is invertible (e.g., ψ=g(θ)), where

$$ψ = g ( θ ) = \frac{2 π L}{λ} cos θ$$

tor ideal antennas.

For example, as shown by the diagram 900A, two antennas (e.g., antenna 1 and antenna 2) of a wireless/tracking device (e.g., the first device 502) may be separated by a distance L and the AoA from a target device (e.g., the second device 504) is θ. Then, the radio signal may head to travel an extra distance δ to one of the antennas (e.g., antenna 1), with δ=L·cos θ. For example, assuming the wireless/tracking device has a pair of ideal isotropic antennas which forms a vector \vec{a} with length L=∥\vec{α}∥, and the wireless/tracking device is at the origin of a coordinate system. Then, the target device is in a position given by a vector \vec{x}_{T}, where the vector \vec{x}_{T} forms an angle θ (e.g., the AoA) with the direction of the antenna vector \vec{α}.

FIG. 9B is a diagram 900B illustrating an example ideal curve for PDoA (ψ) as a function of AoA (θ) in accordance with various aspects of the present disclosure. Under ideal conditions, the PDoA (ψ) measured by the wireless/tracking device may be given by the equation:

$$ψ = g ( θ ) = \frac{2 π L}{λ} cos θ$$

where function g(·) may be referred to as the PDoA function. In this ideal example, function g(·) may be dependent just on the angle θ. This may assume that the wireless/tracking device has a rotational symmetry around the antenna vector \vec{α}. When

$$L < \frac{λ}{2} ,$$

there may be a one-to-one mapping between θ and ψ, so the function may be inverted to obtain θ:

$$θ = arccos ( ψ \cdot \frac{λ}{2 π L} )$$

However, when at least one of the conditions described in connection with FIG. 9A is not met (e.g., each pair of antennas do not meet the condition (L<λ/2) and/or their PDoA function is not invertible), it is generally impossible to compute θ=g⁻¹(ψ) because the function g(·) is not invertible. There may be various reasons why above conditions often cannot be met in consumer products. For example, antennas in consumer products may be designed to be separated as much as possible to maximize multiple-input and multiple-output (MIMO) performance. In another examples, antennas in consumer products may not have an invertible g(θ) because of effects of nearby components (e.g., the antennas are physically blocked by other hardware components). As such, aspects presented herein provide a positioning mechanism that works for tracking devices to track target devices without specifying their antennas to meet the condition (L<λ/2) if the tracking devices and the target devices are capable of using multiple frequencies for PDoA/AoA estimation.

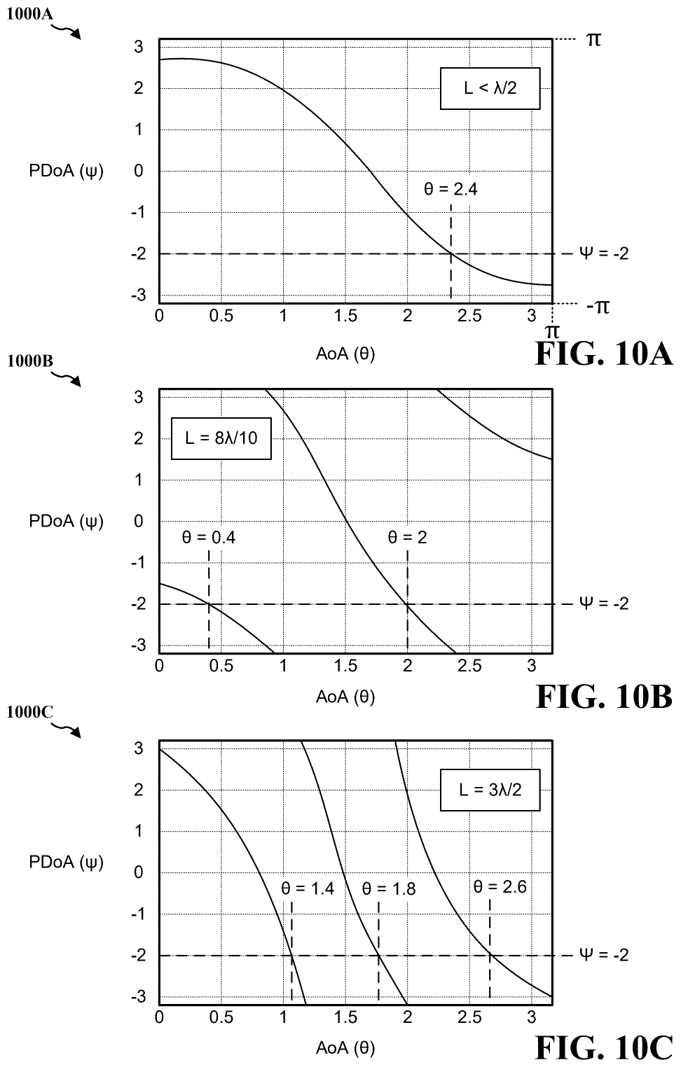

FIGS. 10A, 10B, and 10C are diagrams 1000A, 1000B, and 1000C illustrating example relationships between AoA and PDoA for different antenna separation distances in accordance with various aspects of the present disclosure. As shown by the diagram 1000A, when L<λ/2, a tracking device may determine the AoA (θ) of a target device because just one AoA is consistent with a PDoA (ψ) at any given point. In other words, the function g(·) is invertible where each AoA can be mapped to one PDoA or vice versa. For example, when PDoA is −2 (e.g., ψ=−2), the AoA is approximately 2.4 (e.g., θ=2.4). On the other hand, as shown by the diagram 1000B, when L>λ/2, such as when L=8λ/10, multiple AoAs may be consistent with one PDoA value. For example, when PDoA is −2 (e.g., ψ=−2), there may be two AoAs that are consistent with this PDoA (e.g., θ=0.4 and 2). In other words, two AoAs may be mapped to one PDoA, which may cause an ambiguity to the tracking device (e.g., the tracking device may not know which AoA is the true AoA). Similarly, as shown by the diagram 1000C, when L=3λ/2, there may be three AoAs that are consistent with the PDoA is −2, which may cause an ambiguity to the tracking device. As such, when L>λ/2, the tracking device may not be able to determine which AoA produces a given PDoA w, and the function g(·) may be considered as not invertible.

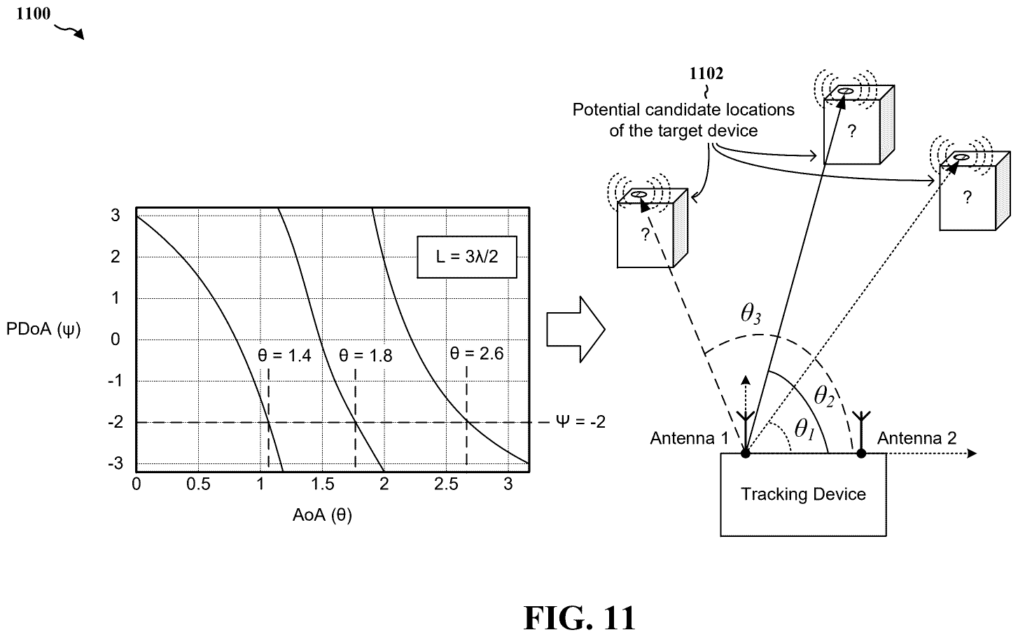

FIG. 11 is a diagram 1100 illustrating an example of a tracking device being unable to distinguish between multiple candidate AoA values in accordance with various aspects of the present disclosure. As shown by the diagram 1100, when a tracking device performs ranging/AoA estimation of a target device using a single frequency with L>λ/2 (e.g., as discussed in connection with FIG. 10C), the tracking device may measure the PDoA (ψ) of the target device and use it to obtain θ=g⁻¹(ψ). As shown at 1102, as there may be multiple candidate AoA values, the tracking device may not know which AoA value corresponds to the actual location of the target device. Thus, the tracking device may not be able to determine the actual location of the target device when L>λ/2.

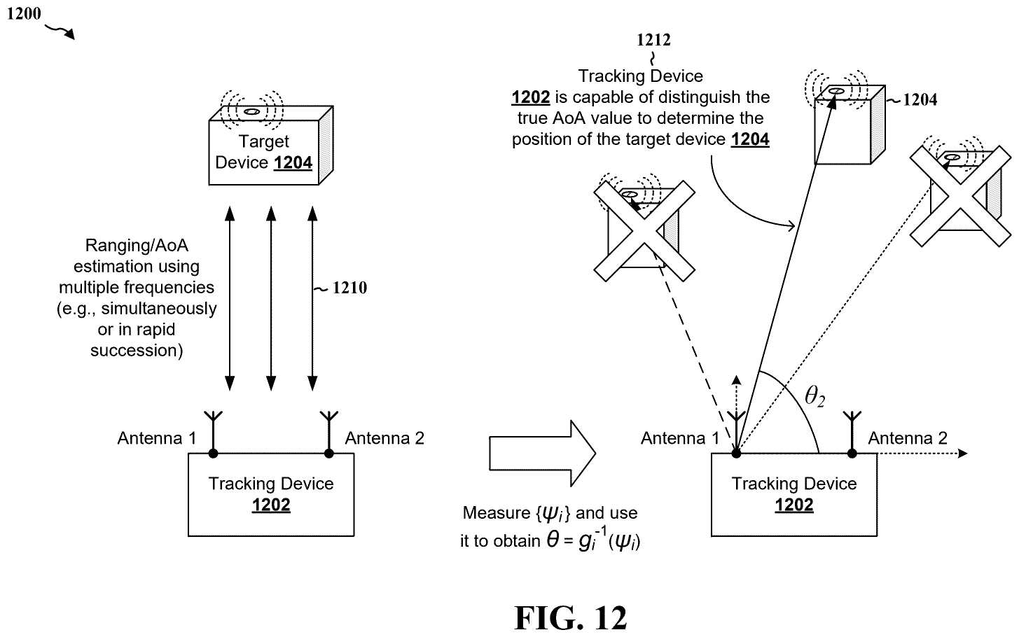

FIG. 12 is a diagram 1200 illustrating an example of a tracking device distinguishing between multiple candidate AoA values based on performing ranging/AoA estimations using multiple frequencies in accordance with various aspects of the present disclosure. In one aspect of the present disclosure, as shown at 1210, to enable a tracking device 1202 to determine the AoA value that corresponds to the actual location of a target device 1204 (e.g., determine the true AoA value from multiple candidate AoA values as discussed in connection with FIG. 11), the tracking device 1202 may be configured to perform multiple ranging/AoA estimation using multiple frequencies (e.g., simultaneously or in a rapid succession).

For example, as shown at 1210, the tracking device 1202 may be configured to measure multiple (N) PDoAs (ψᵢ and i∈{1, . . . , N}) for multiple (N) radio links between the tracking device 1202 and the target device 1204 (e.g., one PDoA per radio link), where each of the multiple radio links is associated with a wavelength (λᵢ) that is different from another radio link in the set of radio links. In addition, the tracking device 1202 may include or use at least two antennas with an antenna separation distance greater than or equal to a threshold (e.g., the threshold may be λᵢ/2 for the corresponding wavelength λᵢ). In other words, the antenna separation distance L>λ/2.

As shown at 1212, after the tracking device 1202 measures multiple PDoAs for multiple radio links (ψᵢ and i∈{1, . . . , N}) between the tracking device 1202 and the target device 1204, the tracking device 1202 may use them to obtain

$$θ = {g}_{i}^{- 1} ( {ψ}_{i} )$$

and find a true AoA value from a list of candidate AoA values. For example, the tracking device 1202 may be configured to determine, based on the multiple PDoAs for the multiple radio links, a general function (μ(θ)) (e.g., a loss function) that is associated with a probability in which the target device 1204 is at a set of relative directions (θs) or a set of relative positions compared to the tracking device 1202. Then, using the determined general function (μ(θ)), the tracking device 1202 may estimate a relative direction (θ) and/or a relative position of the target device 1204 (with respect to/compared to the tracking device 1202).

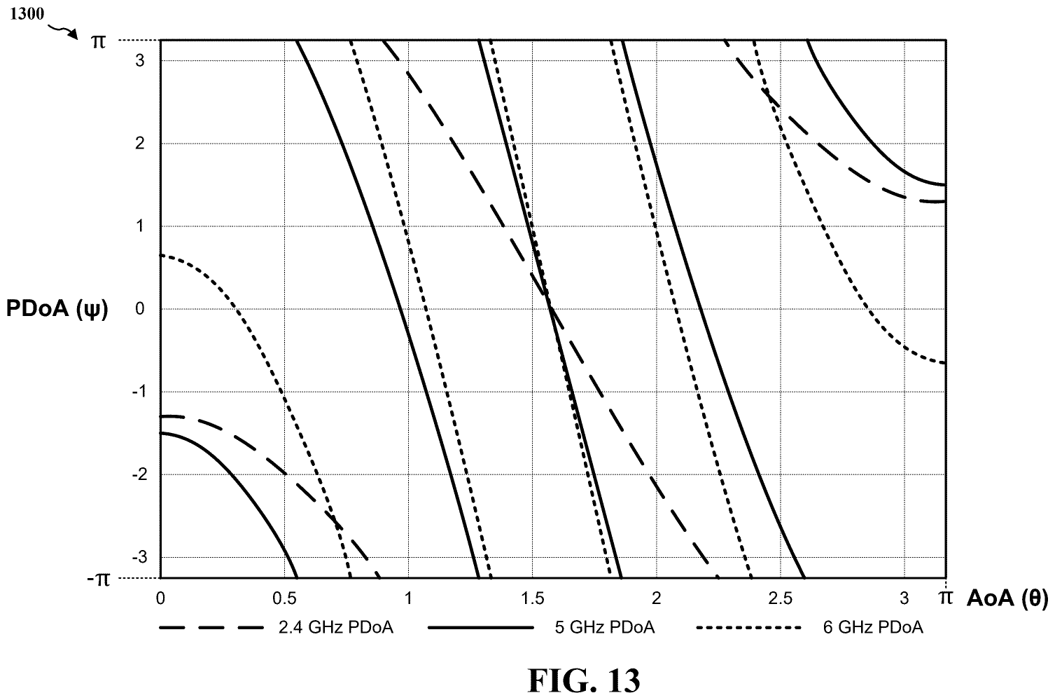

FIG. 13 is a diagram 1300 illustrating examples of PDoA functions with different frequencies in accordance with various aspects of the present disclosure. Aspects discussed in connection with FIG. 12 leverage the fact that the PDoA function (v) depends on the λ of the RF signal

$$( e . g . , ψ = g ( θ ) = \frac{2 π L}{λ} cos θ ) .$$

For example, as shown by the diagram 1300, when the PDoA function is associated with different frequencies (f) (e.g., f=2.4 GHz, 5 GHZ, and 6 GHZ), the relationship between the PDoA values and the AoA values may be different. This means that if the tracking device 1202 and the target device 1204 have the capability to exchange RF signals with more than one center frequency, then the tracking device 1202 (and/or the target device 1204) may be able to disambiguate/determine the true AoA. In some implementations, the tracking device 1202 and the target device 1204 may be configured to exchange RF signals in different frequencies, either simultaneously or in rapid succession (so that tracking device 1202 and the target device 1204 do not move or change their displacements between measurements).

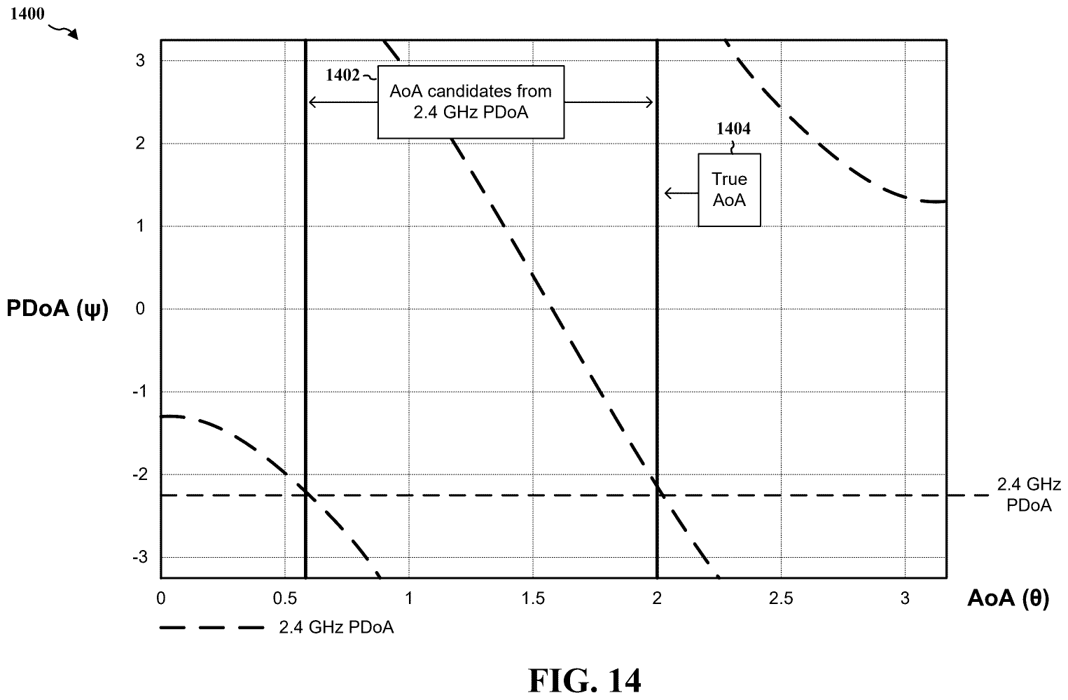

FIG. 14 is a diagram 1400 illustrating an example of AoA candidates when measuring PDoA using 2.4 GHz frequency in accordance with various aspects of the present disclosure. As shown at 1402, when the tracking device 1202 measures the PDoA of signals transmitted from the target device 1204 using 2.4 GHz frequency (meaning the signals are transmitted with 2.4 GHz frequency/center frequency), there may be two AoA candidates (e.g., θ≈0.6 and 2, etc.). As shown at 1404, just one of the AoA candidates (e.g., θ≈2) is the true AoA (e.g., reflect the actual location/direction of the target device 1204 with respect to the tracking device 1202).

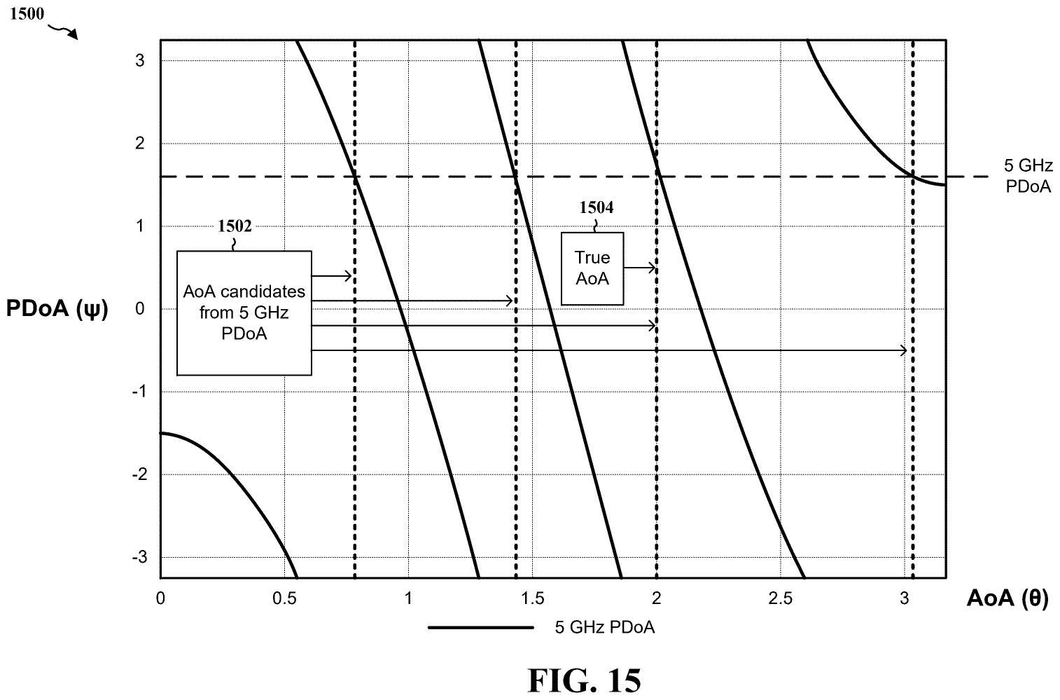

FIG. 15 is a diagram 1500 illustrating an example of AoA candidates when measuring PDoA using 5 GHz frequency in accordance with various aspects of the present disclosure. As shown at 1502, when the tracking device 1202 measures the PDoA of signals transmitted from the target device 1204 using 5 GHz frequency (meaning the signals are transmitted with 5 GHz frequency/center frequency), there may be four AoA candidates (e.g., θ≈0.8, 1.3, 2, and 3.1, etc.). As shown at 1504, just one of the AoA candidates (e.g., θ≈2) is the true AoA (e.g., reflect the actual location/direction of the target device 1204 with respect to the tracking device 1202).

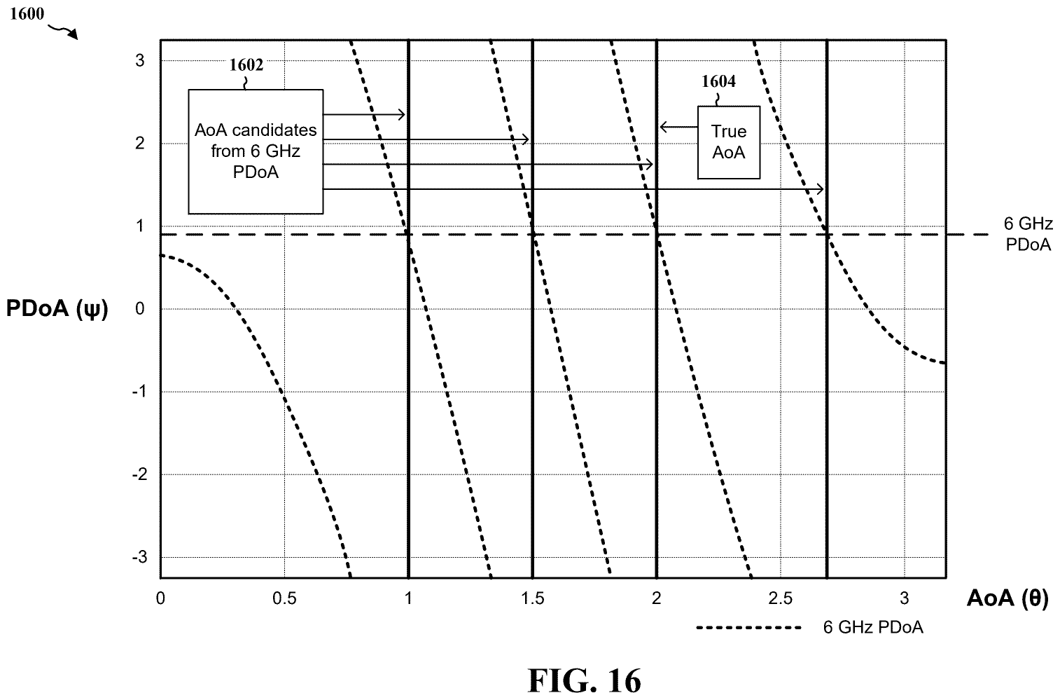

FIG. 16 is a diagram 1600 illustrating an example of AoA candidates when measuring PDoA using 6 GHz frequency in accordance with various aspects of the present disclosure. As shown at 1602, when the tracking device 1202 measures the PDoA of signals transmitted from the target device 1204 using 6 GHz frequency (meaning the signals are transmitted with 5 GHz frequency/center frequency), there may be four AoA candidates (e.g., θ≈1, 1.5, 2, and 2.7, etc.). As shown at 1604, just one of the AoA candidates (e.g., θ≈2) is the true AoA (e.g., reflect the actual location/direction of the target device 1204 with respect to the tracking device 1202).

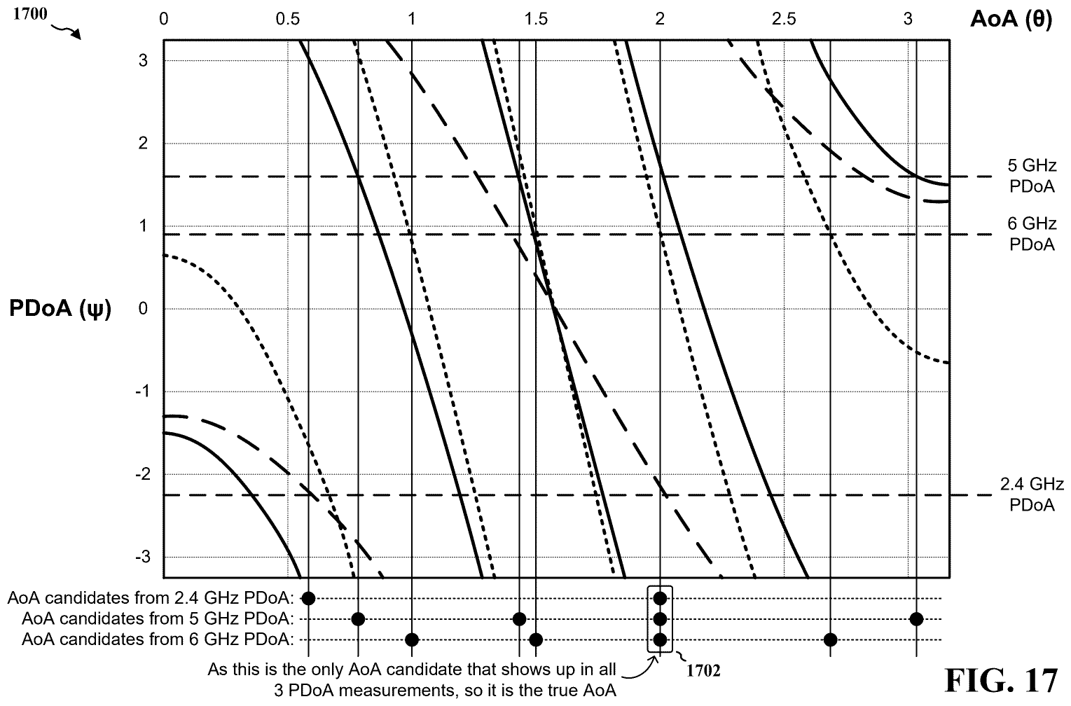

FIG. 17 is a diagram 1700 illustrating an example of finding the true AoA from multiple AoA candidates using multiple frequencies in accordance with various aspects of the present disclosure. In one aspect of the present disclosure, based on measuring the PDoA of signals transmitted from the target device 1204 using multiple frequencies (e.g., 2.4 GHz, 5 GHZ, and 6 GHz as described in connection with FIGS. 14 to 16), the tracking device 1202 may be able to find/determine the true AoA (e.g., the AoA that corresponds to the location/direction of the target device 1204) by finding an AoA candidate that appears on all frequencies. For example, as shown at 1702, as the AoA candidate (θ≈2) appears on each of the 2.4 GHz, 5 GHZ, and 6 GHz PDoA measurements, the tracking device 1202 may determine that this AoA candidate (θ≈2) is the true AoA.

However, in reality, the candidate AoA values for PDoA measurements of different frequencies are unlikely to be (perfectly) aligned with each other. For example, if the true AoA value is 1.9, due to possible measurement noise, the measured AoA value for the 2.4 GHz PDoA measurement may be 1.91 (e.g., θ≈1.91), the measured AoA value for the 5 GHz PDoA measurement may be 1.89 (e.g., θ≈1.89), and measured AoA value for the 6 GHz PDoA measurement may be 1.95 (e.g., θ≈1.95), etc. As such, it may be impractical to configure the tracking device 1202 to compare individual AoA values/angles to determine which AoA(s) show up in all frequency bands.

Accordingly, in another aspect of the present disclosure, the tracking device 1202 may be configured to build a general function, such as a loss function μᵢ(θ), that is capable of scoring each AoA value depending on how compatible it is with the PDoA measured in each frequency band, for i∈{1, . . . , M}. Then, the tracking device 1202 may be configured to choose the AoA value that has the optimized value for the total loss function (e.g., may be a highest value or a lowest value depending on the implementation), which likely is the true AoA value. With this mechanism, the tracking device 1202 may determine the true AoA value/angle without having to move/rotate the tracking device 1202 and also having an antenna separation distance greater than half of the wavelength

$$( L > \frac{λ}{2} ) .$$

The mechanism may be compatible with tracking/ranging technologies discussed in connection with FIG. 5, such as the Wi-Fi, Bluetooth, UWB, etc.

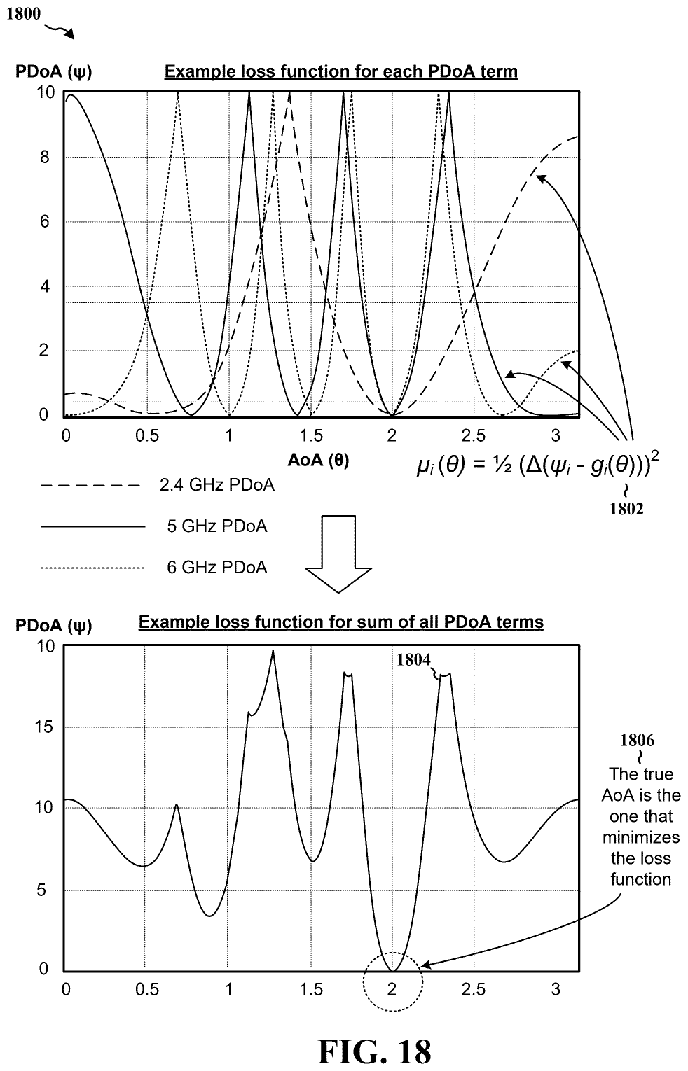

FIG. 18 is a diagram 1800 illustrating an example of building a loss function that is capable of finding the true AoA in accordance with various aspects of the present disclosure. In one example, as shown at 1802, the tracking device 1202 may be configured to build a loss function μᵢ(θ) for the PDoA measured in each frequency band:

$${μ}_{i} ( θ ) = \frac{1}{2} ( {Δ ( {ψ}_{i} - {g}_{i} ( θ ) )}^{2}$$

where i∈{1, . . . , M}, M being the number of frequency bands, gᵢ(θ) is the PDoA function

$$( {g}_{i} \cdot ( θ ) = \frac{2 π L}{{λ}_{i}} cos θ in the ideal case ) ,$$

and Δ(x) is a function for comparing AoA values (Δ(x)={(x+π) mod 2π}−π).

The complete loss function (μ(θ)) (e.g., the loss function for the sum of all PDoA terms) may be represented by and calculated based on:

$$μ ( θ ) = {\sum }_{i = 1}^{M} {μ}_{i} ( θ ) = {\sum }_{i = 1}^{M} \frac{1}{2} ( {Δ ( {ψ}_{i} - g ( θ ) )}^{2}$$

which may be illustrated by the graph/curve lines shown at 1804. Based on this complete loss function, the tracking device 1202 may be able to find the true AoA (θ*) by finding an AoA value that minimizes the complete loss function:

$${θ}^{*} = {arg min}_{θ} \{ μ ( θ ) \}$$

In other words, as shown at 1806, the true AoA is the one that minimizes the complete loss function, which is θ=2 in this example. For purposes of the present disclosure, the term “minimize/minimizing” a function may refer to finding a value for the argument of the function that makes the function achieve a values as small as possible. For example, finding an AoA that minimizes a loss function may refer to finding an AoA value that makes the loss function as small as possible, such as approaching zero. On the other hand, the term “maximize/maximizing” a function may refer to finding a value for the argument of the function that makes the function achieve a values as large as possible. Depending on implementations, the loss function may be configured to either finding a minimum value or a maximum value. For simplicity of illustration, minimize/minimizing and maximize/maximizing may collectively be referred to as “optimize/optimizing.” For example, when a loss function is optimized, it may indicate that the loss function is minimized or maximized. Similarly, the term “minimum” and the term “maximum” may collectively be referred to as “extremum.” As such, while examples described herein may show minimizing a loss function, it may also apply to maximizing a loss function depending on implementations.

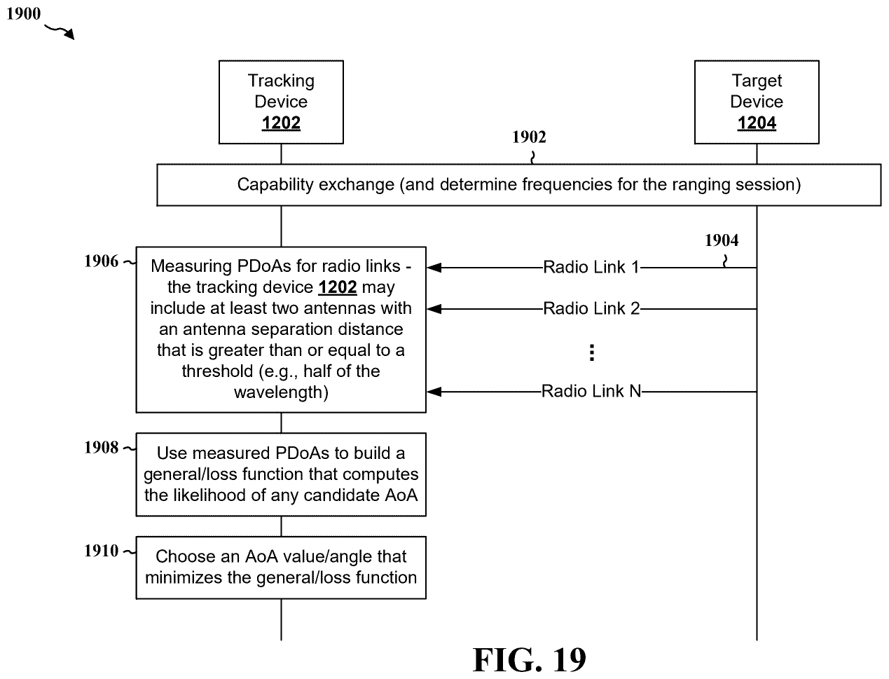

FIG. 19 is a communication flow 1900 illustrating an example algorithm of a tracking device determining the AoA of a target device using multiple frequencies in accordance with various aspects of the present disclosure. The numberings associated with the communication flow 1900 do not specify a particular temporal order and are merely used as references for the communication flow 1900. In some scenarios, at least one of the tracking device and/or the target device may be static or moving slowly (e.g., the speed may be below a defined speed threshold).

At 1902, if the tracking device 1202 is configured to determine the AoA of the target device 1204 (e.g., the relative direction/position of the target device 1204 with respect to or compared to the tracking device 1202), the tracking device 1202 may be configured to exchange related capabilities with the target device 1204. For simplicity of illustration, the process of finding the relative direction/position of the target device 1204 (e.g., finding the AoA corresponds to the target device 1204) may be referred to as “ranging” or a “ranging session.”

For example, at 1902, the tracking device 1202 may (attempt to) initiate a ranging session by transmitting a request message or an inquiry message to the target device 1204 to request the target device 1204 to provide capabilities related to ranging such as: (1) whether the target device 1204 supports multiple frequencies for ranging (simultaneously or in a rapid succession (e.g., close in time)), and/or (2) the ranging technology supported by the target device 1204 (e.g., Wi-Fi, Bluetooth, UWB, or a combination thereof), etc. Then, based the capability information provided by the target device 1204, the tracking device 1202 may communicate with the target device 1204 regarding the frequencies (and also the ranging technology if specified) to be used for a ranging session. In another example, or as an alternative, the tracking device 1202 device may also provide its ranging capabilities to the target device 1204, such as the ranging technology and frequencies supported by the tracking device 1202. Then, if the target device 1204 also supports multiple frequency ranging, the target device 1204 may provide frequencies to be used for a ranging session to the tracking device 1202.

At 1904, based on the number (N) of frequencies (and also the ranging technology if available) selected for the ranging session, the target device 1204 may be configured to transmit signals to the tracking device 1202 via the selected frequencies. For example, the target device 1204 may transmit a first set of reference signals to the tracking device 1202 using a first frequency (which may be referred to as a first radio link or radio link 1), transmit a second set of reference signals to the tracking device 1202 using a second frequency (which may be referred to as a second radio link or radio link 2), and transmit an N^{th} set of reference signals to the tracking device 1202 using an N^{th} frequency (which may be referred to as an N^{th} radio link or radio link N), etc. In addition, to avoid the effect caused by possible displacement(s) of the tracking device 1202 and/or the target device 2104, the target device 2104 may be configured to transmit the reference signals via the multiple frequencies simultaneously (e.g., in parallel) or close in time (e.g., in a rapid succession).

At 1906, based on the reference signals from the target device 1204 via the multiple frequencies (e.g., via multiple radio links), for each radio link i∈{1, . . . , N} with wavelength λᵢ, the tracking device 1202 may measure the PDoA (ψᵢ) for the corresponding set of reference signals, where

$${ψ}_{i} = {g}_{i} ( θ ) = \frac{2 π L}{{λ}_{i}} \cdot cos ( θ ) ,$$

such as described in connection with FIGS. 13 to 17. Note the wavelength λᵢ and the frequency fᵢ are inversely proportional to each other

$$( e . g . , {f}_{i} = \frac{c}{{λ}_{i}} ,$$

where c=3·10⁸ m/s is the speed of light).

At 1908, the tracking device 1202 may use the PDoAs (ψᵢ) to build a general/loss function μ(θ) that is capable of computing the (negative/positive) likelihood of any candidate AoA (θ) based on

$$μ ( θ ) = {\sum }_{i = 1}^{N} {μ}_{i} ( θ ) = {\sum }_{i = 1}^{N} {( \frac{Δ ( {ψ}_{i} - {g}_{i} ( θ ) )}{{σ}_{i}} )}^{2} ,$$

such as described in connection with FIG. 18, where Δ(x) is a function that computes the difference between two values/angles (e.g., Δ(x)={(x+π) mod 2π}−π) and σᵢ is the standard deviation of the PDoA measurement process for radio link i.

At 1910, based on the general/loss function μ(θ), the tracking device 1202 may choose an AoA value/angle (θ) that optimizes the general/loss function, which is likely the true AoA value/angle. In other words, based on the built general/loss function μ(θ), the tracking device 1202 may estimate a relative direction or a relative position of the target device 1204 (with respect or compared to the tracking device 1202).

In some implementations, as aspects presented herein may enable a tracking device (e.g., the tracking device 1202) to find the AoA/PDoA of a target device (e.g., the target device 1204) using a pair of antennas that has an antenna separation distance greater than half of the wavelength

$$( L > \frac{{λ}_{i}}{2} ) ,$$

the tracking device may be configured to initiate/trigger the mechanism discussed in connection with FIG. 18 based on the certain pre-defined conditions (in addition to having the capability to perform multi-frequency ranging), such as based on (1) both the tracking device and the target device are not moving and/or (2) at least one of the frequencies (λᵢ) used for the multi-frequency ranging will cause the antenna separation distance (L) of the tracking device 1202 to be greater than half of the wavelength

$$( L > \frac{{λ}_{i}}{2} ) ,$$

which may be described as an antenna separation distance that is greater than or equal to a threshold. If the pre-defined condition(s) are not met, the tracking device 1202 may be configured to use other mechanism(s) to find the AoA of the target device 1204. In addition, at least one of the tracking device or the target device or both may be static or moving slowly.

In some implementations, if the tracking device 1202 also has distance information between the tracking device 1202 and the target device 1204, the tracking device 1202 may be able to determine the location of the target device 1204. In other words, the tracking device 1202 may be able to estimate the location of the target device 1204.

In some implementations, the tracking device 1202 may be configured to display, via a user interface (UI), the relative direction or the relative position of the tracking device 1202 compared to the target device 1204, such as displaying a direction of the target device 1204 from the tracking device 1202, displaying a distance of the target device 1204 from the tracking device 1202, and/or displaying an image or a description of the target device 1204, etc.

In some implementations, the tracking device 1202 may be configured to output an indication of the relative direction or the relative position of the target device 1204 compared to the tracking device 1202, such as transmitting the indication of the relative direction or the relative position of the target device 1204 compared to the tracking device 1202, or store the indication of the relative direction of the target device 1204 or the relative position compared to the tracking device 1202.

While the example algorithm discussed in connection with FIGS. 18 and 19 are based on two-dimensional (2D) scenarios (e.g., just the AoA (θ) is determined), aspects presented herein may also apply to three-dimensional (3D) scenarios, with potential rotation/displacement of the tracking device 1202. In other words, the tracking device 1202 may also be moving while estimating/finding the (true) AoA of the target device 1204. For example, if the tracking device 1202 is a mobile phone, the user of the mobile phone may potentially moving/rotating the mobile phone (maybe involuntarily) while the PDoA measurements are being taken.

Accordingly, in another aspect of the present disclosure, the tracking device 1202 may be configured to build a general/loss function that is capable of assigning a (negative) likelihood to each point in a space \vec{x}, and the tracking device 1202 may be configured to find a point (e.g., a 3D coordinate) in space with the lowest value of the (negative) likelihood, which may corresponds to the location/direction of the target device 1204 as described in connection with FIGS. 17 to 19.

For purposes of illustration, assuming the position of the tracking device 1202 is denoted by (\vec{pₗ}) and the rotation of the tracking device 1202 is described by a rotation matrix (Uᵢ). Depending on implementations, the tracking device 1202 may obtain the (\vec{pₗ}, Uᵢ) from a visual/inertial odometry (VIO) system on the tracking device 1202. It may be assumed that the target device 1204 may be in any location in a 3D space.

In one aspect, the tracking device 1202 may build a general/loss function that assigns a (negative) likelihood to each point in the space \vec{x} based on the followings:
(1) the tracking device 1202 may consider an arbitrary point in space:
   \vec{x}
(2) the tracking device 1202 may compute the vector from the position of the tracking device 1202 \vec{pₗ} to the point \vec{x}:

$$\vec{x} - \vec{{p}_{ι}}$$

(3) the tracking device 1202 may convert it to the reference frame of the rotated tracking device 1202:

$${U}_{i}^{T} \cdot ( \vec{x} - \vec{{p}_{ι}} )$$

(4) the tracking device 1202 may convert from Cartesian to spherical coordinates:

$$q ( {U}_{i}^{T} \cdot ( \vec{x} - \vec{{p}_{ι}} ) )$$

(5) the tracking device 1202 may compute its PDoA using the function gᵢ(θ, ϕ) which is dependent on the wavelength λᵢ used for the i-th measurement (this is where multi-frequency operation is specified):

$${g}_{i} ( q ( {U}_{i}^{T} \cdot ( \vec{x} - \vec{{p}_{ι}} ) ) )$$

(6) the tracking device 1202 may compare the candidate PDoA with the measured PDoA ψᵢ based on:

$$Δ [ {g}_{i} ( q ( {U}_{i}^{T} \cdot ( \vec{x} - \vec{{p}_{l}} ) ) ) - {ψ}_{i} ]$$

(7) the tracking device 1202 may normalize it (e.g., using the standard deviation) and square it:

$${( \frac{Δ [ {g}_{i} ( q ( {U}_{i}^{T} \cdot ( \vec{x} - \vec{{p}_{l}} ) ) ) - {ψ}_{i} ]}{{σ}_{{ψ}_{i}}} )}^{2}$$

(8) the tracking device 1202 may now add up all the terms for i∈{1, . . . , N}

$$μ ( x ) = {\sum }_{i = 1}^{N} {( \frac{Δ [ {g}_{i} ( q ( {U}_{i}^{T} \cdot ( \vec{x} - \vec{{p}_{l}} ) ) ) - {ψ}_{i} ]}{{σ}_{{ψ}_{i}}} )}^{2}$$

(9) the tracking device 1202 may find the point where u (x) is the smallest based on:

$$\vec{{x}^{*}} = {arg min}_{\vec{x}} \{ μ ( \vec{x} ) \}$$

This point may correspond to relative position/location of the target device 1204 with respect to the tracking device 1202 in the space.

Aspects presented herein may improve the overall performance of positioning/tracking between wireless devices that are likely to be by enabling the wireless devices to perform the positioning/tracking using multiple wavelength. Aspects presented herein may enable a tracking device to locate a target device based on using multiple frequencies for the AoA estimation, such that the tracking device may have an antenna separation distance greater than half of the communication wavelength (e.g., antenna separation distance (L)>wavelength (λ)/2). In general, if a fixed device (for example, a TV) wants to use AoA techniques to detect the relative position of some other device, then the antennas of the fixed device may be specified to be close to each other to ensure their separation meets

$$L < \frac{λ}{2} .$$

This may be unsuitable for wireless communication performance, because this may reduce the diversity obtained from multiple antennas (e.g., if one antenna is blocked due to a person standing in front of it, then other antennas are also likely to be blocked). However, aspects presented herein may enable manufacturers of wireless devices to configure/put AoA antennas farther apart from each other, ensuring they provide good diversity when used for communication, and still being able to function for AoA estimation.

Aspects presented herein rely on using multiple frequencies when exchanging RF signals for AoA estimation (either simultaneously or in rapid succession), in cases in which antenna separation is larger than λ/2. The tracking device may be specified to request the target device to send RF signals over 2 or more frequencies, because L>λ/2 each PDoA measurement ψᵢ may map to multiple AoA candidate angles {θᵢ₁, . . . , θ_{iK}}. However, as one specific value of θ can be found in all the sets of AoA candidates, the tracking device may detect that specific value as the true AoA θ. While aspects presented herein may remove the specification for the tracking device to move/rotate to remove ambiguity, aspects presented herein also support the case in which the tracking device is moved.

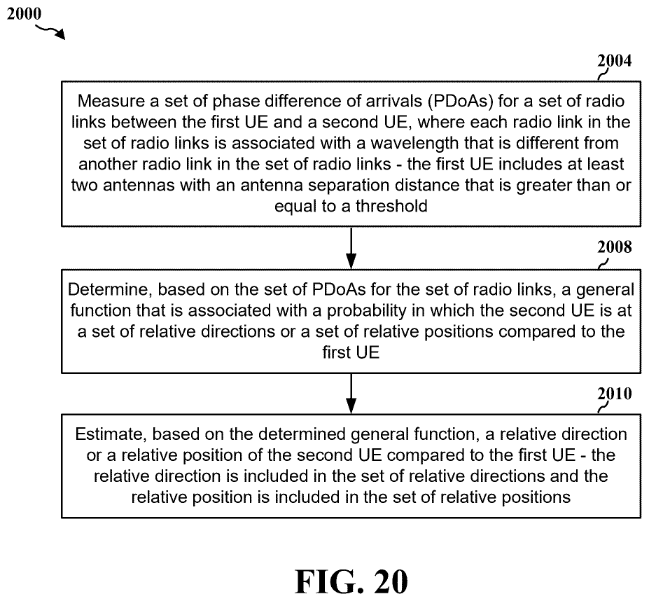

FIG. 20 is a flowchart 2000 of wireless communication at a user equipment (UE). The method may be performed by a UE (e.g., the UE 104, 404; the first device 502; the tracking device 1202; the apparatus 2204). The method may enable a first UE to estimate the AoA of a second UE using multiple ranging frequencies, where at least one of the first UE or the second UE may be static/moving slowly and the antenna separation distance of the first UE may be greater than half of the wavelength used for the ranging.

At 2004, the first UE may measure a set of phase difference of arrivals (PDoAs) (e.g., ψᵢ and i∈{1, . . . , N}) for a set of radio links (e.g., N radio links) between the first UE and a second UE, where each radio link in the set of radio links is associated with a wavelength (λᵢ) that is different from another radio link in the set of radio links, where the first UE includes at least two antennas with an antenna separation distance that is greater than or equal to a threshold, such as described in connection with FIGS. 17 to 19. For example, as discussed in connection with 1906 of FIG. 19, based on the reference signals from the target device 1204 via the multiple frequencies (e.g., via multiple radio links), for each radio link i∈{1, . . . , N} with wavelength λᵢ, the tracking device 1202 may measure the PDoA (ψᵢ) for the corresponding set of reference signals, where

$${ψ}_{i} = {g}_{i} ( θ ) = \frac{2 π L}{{λ}_{i}} \cdot cos ( θ ) .$$

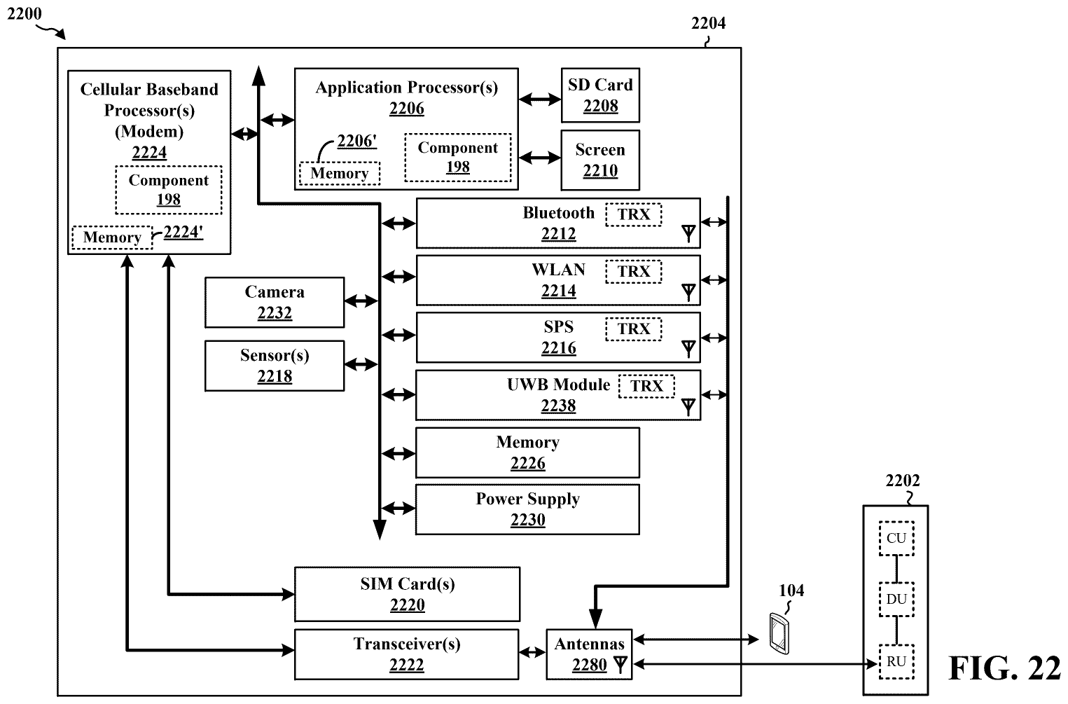

The measurement of the set of PDoAs may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, to measure the set of PDoAs for the set of radio links between the first UE and the second UE, the first UE may be configured to receive, from the second UE, a set of signals from each radio link in the set of radio links parallelly or consecutively, and measure a PDoA for the set of signals from each radio link in the set of radio links to obtain the set of PDoAs for the set of radio links. In some implementation, the first UE may transmit, to the second UE, a request to send the set of signals via at least two radio links with two or more frequencies, where reception of the set of signals from each radio link in the set of radio links parallelly or consecutively is based on the request. In some implementations, the first UE may initiate a ranging session with the second UE, where transmission of the request is based on the initiation of the ranging session.

In another example, the threshold is equal to λ/2 for at least one wavelength associated with each radio link in the set of radio links, A being the wavelength associated with each radio link in the set of radio links.

At 2008, the first UE may determine, based on the set of PDoAs for the set of radio links, a general function (e.g., μ(θ)) that is associated with a probability in which the second UE is at a set of relative directions (e.g., θs) or a set of relative positions compared to the first UE, such as described in connection with FIGS. 17 to 19. For example, as discussed in connection with 1908 of FIG. 19, the tracking device 1202 may use the PDoAs (ψᵢ) to build a general/loss function μ(θ) that is capable of computing the (negative/positive) likelihood of any candidate AoA (θ) based on

$$μ ( θ ) = {\sum }_{i = 1}^{N} {μ}_{i} ( θ ) = {\sum }_{i = 1}^{N} {( \frac{Δ ( {ψ}_{i} - {g}_{i} ( θ ) )}{{σ}_{i}} )}^{2} .$$

The determination of the general function may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, the general function corresponds to a loss function that is capable of determining a negative likelihood of a candidate angle-of-arrival (AoA) or a candidate position associated with the second UE.

In another example, the set of relative directions corresponds to a set of AoA candidates, and to estimate, based on the determined general function, the relative direction of the second UE compared to the first UE, the first UE may be configured to determine an AoA candidate from the set of AoA candidates that optimizes the general function, and identify the relative direction of the second UE based on the determined AoA candidate.

In another example, the set of relative positions corresponds to a set of three-dimensional (3D) coordinate candidates, and where to estimate, based on the determined general function, the relative position of the second UE compared to the first UE, the first UE may be configured to determine a 3D coordinate candidate from the set of 3D coordinate candidates that optimizes the general function, and identify the relative position of the second UE based on the determined 3D coordinate candidate.

At 2010, the first UE may estimate, based on the determined general function, a relative direction (e.g., θ) or a relative position of the second UE compared to the first UE, where the relative direction is included in the set of relative directions and the relative position is included in the set of relative positions, such as described in connection with FIGS. 17 to 19. For example, as discussed in connection with 1910 of FIG. 19, based on the built general/loss function μ(θ), the tracking device 1202 may choose an AoA value/angle (θ) that optimizes the loss function, which is likely the true AoA value. In other words, based on the built general/loss function μ(θ), the tracking device 1202 may estimate a relative direction or a relative position of the target device 1204 (with respect or compared to the tracking device 1202). The estimation of the relative direction or the relative position of the second UE may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, the first UE may transmit, to the second UE, a request to send the set of signals via at least two radio links with two or more frequencies, where reception of the set of signals from each radio link in the set of radio links parallelly or consecutively is based on the request, such as described in connection with FIGS. 17 to 19. For example, as discussed in connection with 1902 of FIG. 19, the tracking device 1202 may (attempt to) initiate a ranging session by transmitting a request message or an inquiry message to the target device 1204 to request the target device 1204 to provide capabilities related to ranging such as: (1) whether the target device 1204 supports multiple frequencies for ranging (simultaneously or in a rapid succession (e.g., close in time)), and/or (2) the ranging technology supported by the target device 1204 (e.g., Wi-Fi, Bluetooth, UWB, or a combination thereof), etc. Then, based the capability information provided by the target device 1204, the tracking device 1202 may communicate with the target device 1204 regarding the frequencies (and also the ranging technology if specified) to be used for a ranging session. The transmission of the request may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In another example, the first UE may determine a vector (\vec{x}−\vec{pₗ}) from a position of the first UE(\vec{pₗ}) to a selected point (\vec{x}) in space, and convert the vector (\vec{x}−\vec{pₗ}) to a reference frame (Uᵢ^{T}·(\vec{x}−\vec{pₗ})) of the first UE, where the measurement of the set of PDoAs is based on the reference frame Uᵢ^{T}·(\vec{x}−\vec{pₗ}), such as described in connection with FIGS. 17 to 19. For example, as discussed in connection with 1906 of FIG. 19, the tracking device 1202 may compute the vector from the position of the tracking device 1202 \vec{pₗ} to the point \vec{x}: \vec{x}−\vec{pₗ}, the tracking device 1202 may convert it to the reference frame of the rotated tracking device 1202: Uᵢ^{T}·(\vec{x}−\vec{pₗ}), the tracking device 1202 may convert from cartesian to spherical coordinates:

$$q ( {U}_{i}^{T} \cdot ( \vec{x} - \vec{{p}_{l}} ) ) ,$$

and the tracking device 1202 may compute its PDoA using the function gᵢ(θ, ϕ) which is dependent on the wavelength λᵢ used for the i-th measurement (this is where multi-frequency operation is specified):

$${g}_{i} ( q ( {U}_{i}^{T} \cdot ( \vec{x} - \vec{{p}_{l}} ) ) ) .$$

The determination of the vector and/or the conversion of the vector may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22. In some implementations, the reference frame corresponds to a set of spherical coordinates.

In another example, the first UE may obtain distance information between the first UE and the second UE, and determine, based on the distance information and the relative direction of the second UE, a second relative location of the second UE with respect to the first UE, such as described in connection with FIGS. 17 to 19. For example, as discussed in connection with 1906 of FIG. 19, in some implementations, if the tracking device 1202 also has distance information between the tracking device 1202 and the target device 1204, the tracking device 1202 may be able to determine the location of the target device 1204. In other words, the tracking device 1202 may be able to estimate the location of the target device 1204. The obtainment of the distance information and/or the determination of the second relative location of the second UE with respect to the first UE may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In another example, the first UE may display, via a user interface (UI), the relative direction or the relative position of the second UE compared to the first UE. In some implementations, to display, via the UI, the relative direction or the relative position of the second UE compared to the first UE, the first UE may be configured to at least one of: display a direction of the second UE from the first UE, display a distance of the second UE from the first UE, or display an image or a description of the second UE.

In another example, the first UE may output an indication of the relative direction or the relative position of the second UE compared to the first UE. In some implementations, to output the indication of the relative direction or the relative position of the second UE compared to the first UE, the first UE may be configured to transmit the indication of the relative direction or the relative position of the second UE compared to the first UE, or store the indication of the relative direction of the second UE or the relative position compared to the first UE.

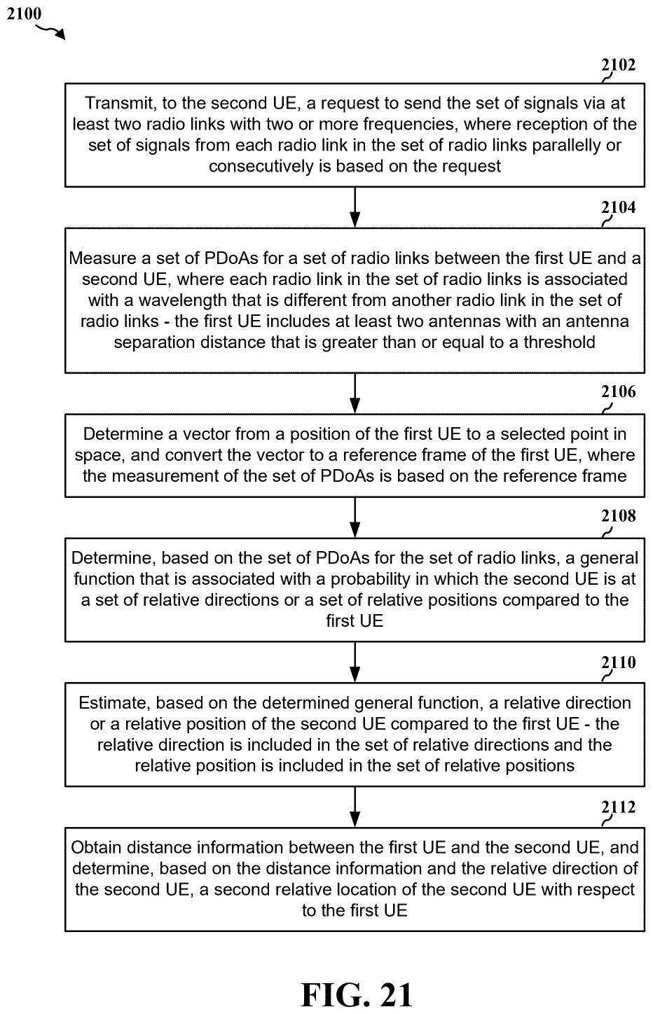

FIG. 21 is a flowchart 2100 of wireless communication at a user equipment (UE). The method may be performed by a UE (e.g., the UE 104, 404; the first device 502; the tracking device 1202; the apparatus 2204). The method may enable a first UE to estimate the AoA of a second UE using multiple ranging frequencies, where at least one of the first UE or the second UE may be static/moving slowly and the antenna separation distance of the first UE may be greater than half of the wavelength used for the ranging.

At 2104, the first UE may measure a set of PDoAs for a set of radio links between the first UE and a second UE, where each radio link in the set of radio links is associated with a wavelength that is different from another radio link in the set of radio links, where the first UE includes at least two antennas with an antenna separation distance that is greater than or equal to a threshold, such as described in connection with FIGS. 17 to 19. For example, as discussed in connection with 1906 of FIG. 19, based on the reference signals from the target device 1204 via the multiple frequencies (e.g., via multiple radio links), for each radio link i∈{1, . . . , N} with wavelength λᵢ, the tracking device 1202 may measure the PDoA (ψᵢ) for the corresponding set of reference signals, where

$${ψ}_{i} = {g}_{i} ( θ ) = \frac{2 π L}{{λ}_{i}} \cdot cos ( θ ) .$$

The measurement of the set of PDoAs may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, to measure the set of PDoAs for the set of radio links between the first UE and the second UE, the first UE may be configured to receive, from the second UE, a set of signals from each radio link in the set of radio links parallelly or consecutively, and measure a PDoA for the set of signals from each radio link in the set of radio links to obtain the set of PDoAs for the set of radio links. In some implementation, the first UE may transmit, to the second UE, a request to send the set of signals via at least two radio links with two or more frequencies, where reception of the set of signals from each radio link in the set of radio links parallelly or consecutively is based on the request. In some implementations, the first UE may initiate a ranging session with the second UE, where transmission of the request is based on the initiation of the ranging session.

In another example, the threshold is equal to λ/2 for at least one wavelength associated with each radio link in the set of radio links, λ being the wavelength associated with each radio link in the set of radio links.

At 2108, the first UE may determine, based on the set of PDoAs for the set of radio links, a general function that is associated with a probability in which the second UE is at a set of relative directions or a set of relative positions compared to the first UE, such as described in connection with FIGS. 17 to 19. For example, as discussed in connection with 1908 of FIG. 19, the tracking device 1202 may use the PDoAs (ψᵢ) to build a general/loss function μ(θ) that is capable of computing the (negative/positive) likelihood of any candidate AoA (θ) based on

$$μ ( θ ) = {\sum }_{i = 1}^{N} {μ}_{i} ( θ ) = {\sum }_{i = 1}^{N} {( \frac{Δ ( {ψ}_{i} - {g}_{i} ( θ ) )}{{σ}_{i}} )}^{2} .$$

The determination of the general function may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, the general function corresponds to a loss function that is capable of determining a negative likelihood of a candidate angle-of-arrival or a candidate position associated with the second UE.

In another example, the set of relative directions corresponds to a set of angle-of-arrival candidates, and to estimate, based on the determined general function, the relative direction of the second UE compared to the first UE, the first UE may be configured to determine an AoA candidate from the set of AoA candidates that optimizes the general function, and identify the relative direction of the second UE based on the determined AoA candidate.

In another example, the set of relative positions corresponds to a set of 3D coordinate candidates, and where to estimate, based on the determined general function, the relative position of the second UE compared to the first UE, the first UE may be configured to determine a 3D coordinate candidate from the set of 3D coordinate candidates that optimizes the general function, and identify the relative position of the second UE based on the determined 3D coordinate candidate.

At 2110, the first UE may estimate, based on the determined general function, a relative direction or a relative position of the second UE compared to the first UE, where the relative direction is included in the set of relative directions and the relative position is included in the set of relative positions, such as described in connection with FIGS. 17 to 19. For example, as discussed in connection with 1910 of FIG. 19, based on the built general/loss function μ(θ) the tracking device 1202 may choose an AoA value/angle (θ) that optimizes the loss function, which is likely the true AoA value. In other words, based on the built general/loss function μ(θ), the tracking device 1202 may estimate a relative direction or a relative position of the target device 1204 (with respect or compared to the tracking device 1202). The estimation of the relative direction or the relative position of the second UE may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In one example, as shown at 2102, the first UE may transmit, to the second UE, a request to send the set of signals via at least two radio links with two or more frequencies, where reception of the set of signals from each radio link in the set of radio links parallelly or consecutively is based on the request, such as described in connection with FIGS. 17 to 19. For example, as discussed in connection with 1902 of FIG. 19, the tracking device 1202 may (attempt to) initiate a ranging session by transmitting a request message or an inquiry message to the target device 1204 to request the target device 1204 to provide capabilities related to ranging such as: (1) whether the target device 1204 supports multiple frequencies for ranging (simultaneously or in a rapid succession (e.g., close in time)), and/or (2) the ranging technology supported by the target device 1204 (e.g., Wi-Fi, Bluetooth, UWB, or a combination thereof), etc. Then, based the capability information provided by the target device 1204, the tracking device 1202 may communicate with the target device 1204 regarding the frequencies (and also the ranging technology if specified) to be used for a ranging session. The transmission of the request may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In another example, as shown at 2106, the first UE may determine a vector from a position of the first UE to a selected point in space, and convert the vector to a reference frame of the first UE, where the measurement of the set of PDoAs is based on the reference frame such as described in connection with FIGS. 17 to 19. For example, as discussed in connection with 1906 of FIG. 19, the tracking device 1202 may compute the vector from the position of the tracking device 1202 \vec{pₗ} to the point \vec{x}: \vec{x}−\vec{pₗ}, the tracking device 1202 may convert it to the reference frame of the rotated tracking device 1202:

$${U}_{i}^{T} \cdot ( \vec{x} - \vec{{p}_{l}} ) ,$$

the tracking device 1202 may convert from cartesian to spherical coordinates

$$q ( {U}_{i}^{T} \cdot ( \vec{x} - \vec{{p}_{l}} ) ) ,$$

and the tracking device 1202 may compute its PDoA using the function gᵢ(θ, ϕ) which is dependent on the wavelength λᵢ used for the i-th measurement (this is where multi-frequency operation is specified):

$${g}_{i} ( q ( {U}_{i}^{T} \cdot ( \vec{x} - \vec{{p}_{l}} ) ) ) .$$

The determination of the vector and/or the conversion of the vector may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22. In some implementations, the reference frame corresponds to a set of spherical coordinates.

In another example, as shown at 2112, the first UE may obtain distance information between the first UE and the second UE, and determine, based on the distance information and the relative direction of the second UE, a second relative location of the second UE with respect to the first UE, such as described in connection with FIGS. 17 to 19. For example, as discussed in connection with 1906 of FIG. 19, in some implementations, if the tracking device 1202 also has distance information between the tracking device 1202 and the target device 1204, the tracking device 1202 may be able to determine the location of the target device 1204. In other words, the tracking device 1202 may be able to estimate the location of the target device 1204. The obtainment of the distance information and/or the determination of the second relative location of the second UE with respect to the first UE may be performed by, e.g., the multi-frequency ranging component 198, the transceiver(s) 2222, the Bluetooth module 2212, the WLAN module 2214, the UWB module 2238, the cellular baseband processor(s) 2224, and/or the application processor(s) 2206 of the apparatus 2204 in FIG. 22.

In another example, the first UE may display, via a UI, the relative direction or the relative position of the second UE compared to the first UE. In some implementations, to display, via the UI, the relative direction or the relative position of the second UE compared to the first UE, the first UE may be configured to at least one of: display a direction of the second UE from the first UE, display a distance of the second UE from the first UE, or display an image or a description of the second UE. In another example, the first UE may output an indication of the relative direction or the relative position of the second UE compared to the first UE. In some implementations, to output the indication of the relative direction or the relative position of the second UE compared to the first UE, the first UE may be configured to transmit the indication of the relative direction or the relative position of the second UE compared to the first UE, or store the indication of the relative direction of the second UE or the relative position compared to the first UE.

FIG. 22 is a diagram 2200 illustrating an example of a hardware implementation for an apparatus 2204. The apparatus 2204 may be a UE (e.g., a first UE), a component of a UE, or may implement UE functionality. In some aspects, the apparatus 2204 may include at least one cellular baseband processor 2224 (also referred to as a modem) coupled to one or more transceivers 2222 (e.g., cellular RF transceiver). The cellular baseband processor(s) 2224 may include at least one on-chip memory 2224′. In some aspects, the apparatus 2204 may further include one or more subscriber identity modules (SIM) cards 2220 and at least one application processor 2206 coupled to a secure digital (SD) card 2208 and a screen 2210. The application processor(s) 2206 may include on-chip memory 2206′. In some aspects, the apparatus 2204 may further include a Bluetooth module 2212, a WLAN module 2214, an ultrawide band (UWB) module 2238 (e.g., a UWB transceiver), an SPS module 2216 (e.g., GNSS module), one or more sensors 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the UWB module 2238, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize the antennas 2280 for communication. The cellular baseband processor(s) 2224 communicates through the transceiver(s) 2222 via one or more antennas 2280 with the UE 104 and/or with an RU associated with a network entity 2202. The cellular baseband processor(s) 2224 and the application processor(s) 2206 may each include a computer-readable medium/memory 2224′, 2206′, respectively. The additional memory modules 2226 may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The cellular baseband processor(s) 2224 and the application processor(s) 2206 are configured to perform the various functions described supra based at least in part of the information stored in the memory. That is, the cellular baseband processor(s) 2224 and the application processor(s) 2206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 350 and may include the at least one memory 360 and/or at least one of the TX processor 368, the RX processor 356, and the controller/processor 359. In one configuration, the apparatus 2204 may be at least one processor chip (modem and/or application) and include just the cellular baseband processor(s) 2224 and/or the application processor(s) 2206, and in another configuration, the apparatus 2204 may be the entire UE (e.g., see UE 350 of FIG. 3) and include the additional modules of the apparatus 2204.

As discussed supra, the multi-frequency ranging component 198 may be configured to measure a set of PDoAs for a set of radio links between the first UE and a second UE, where each radio link in the set of radio links is associated with a wavelength that is different from another radio link in the set of radio links, where the first UE includes at least two antennas with an antenna separation distance that is greater than or equal to a threshold. The multi-frequency ranging component 198 may also be configured to determine, based on the set of PDoAs for the set of radio links, a general function that is associated with a probability in which the second UE is at a set of relative directions or a set of relative positions compared to the first UE. The multi-frequency ranging component 198 may also be configured to estimate, based on the determined general function, a relative direction or a relative position of the second UE compared to the first UE, where the relative direction is included in the set of relative directions and the relative position is included in the set of relative positions. The multi-frequency ranging component 198 may be within the cellular baseband processor(s) 2224, the application processor(s) 2206, or both the cellular baseband processor(s) 2224 and the application processor(s) 2206. The multi-frequency ranging component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for measuring a set of PDoAs for a set of radio links between the first UE and a second UE, where each radio link in the set of radio links is associated with a wavelength that is different from another radio link in the set of radio links, where the first UE includes at least two antennas with an antenna separation distance that is greater than or equal to a threshold. The apparatus 2204 may further include means for determining, based on the set of PDoAs for the set of radio links, a general function that is associated with a probability in which the second UE is at a set of relative directions or a set of relative positions compared to the first UE. The apparatus 2204 may further include means for estimating, based on the determined general function, a relative direction or a relative position of the second UE compared to the first UE, where the relative direction is included in the set of relative directions and the relative position is included in the set of relative positions.

In one configuration, the means for measuring the set of PDoAs for the set of radio links between the first UE and the second UE may include configuring the apparatus 2204 to receive, from the second UE, a set of signals from each radio link in the set of radio links parallelly or consecutively, and measure a PDoA for the set of signals from each radio link in the set of radio links to obtain the set of PDoAs for the set of radio links. In some implementation, the apparatus 2204 may further include means for transmitting, to the second UE, a request to send the set of signals via at least two radio links with two or more frequencies, where reception of the set of signals from each radio link in the set of radio links parallelly or consecutively is based on the request. In some implementations, the apparatus 2204 may further include means for initiating a ranging session with the second UE, where transmission of the request is based on the initiation of the ranging session.

In another configuration, the threshold is equal to λ/2 for at least one wavelength associated with each radio link in the set of radio links, λ being the wavelength associated with each radio link in the set of radio links.

In another configuration, the general function corresponds to a loss function that is capable of determining a negative likelihood of a candidate AoA or a candidate position associated with the second UE.

In another configuration, the set of relative directions corresponds to a set of AoA candidates, and the means for estimating, based on the determined general function, the relative direction of the second UE compared to the first UE may include configuring the apparatus 2204 to determine an AoA candidate from the set of AoA candidates that optimizes the general function, and identify the relative direction of the second UE based on the determined AoA candidate.

In another configuration, the set of relative positions corresponds to a set of 3D coordinate candidates, and the means for estimating, based on the determined general function, the relative position of the second UE compared to the first UE may include configuring the apparatus 2204 to determine a 3D coordinate candidate from the set of 3D coordinate candidates that optimizes the general function, and identify the relative position of the second UE based on the determined 3D coordinate candidate.

In another configuration, the apparatus 2204 may further include means for transmitting, to the second UE, a request to send the set of signals via at least two radio links with two or more frequencies, where reception of the set of signals from each radio link in the set of radio links parallelly or consecutively is based on the request.

In another configuration, the apparatus 2204 may further include means for determining a vector from a position of the first UE to a selected point in space, and means for converting the vector to a reference frame of the first UE, where the measurement of the set of PDoAs is based on the reference frame. In some implementations, the reference frame corresponds to a set of spherical coordinates.

In another configuration, the apparatus 2204 may further include means for obtaining distance information between the first UE and the second UE, and means for determining, based on the distance information and the relative direction of the second UE, a second relative location of the second UE with respect to the first UE.

In another configuration, the apparatus 2204 may further include means for displaying, via a UI, the relative direction or the relative position of the second UE compared to the first UE. In some implementations, the means for displaying, via the UI, the relative direction or the relative position of the second UE compared to the first UE may include configuring the apparatus 2204 to at least one of: display a direction of the second UE from the first UE, display a distance of the second UE from the first UE, or display an image or a description of the second UE.

In another configuration, the apparatus 2204 may further include means for outputting an indication of the relative direction or the relative position of the second UE compared to the first UE. In some implementations, the means for outputting the indication of the relative direction or the relative position of the second UE compared to the first UE may include configuring the apparatus 2204 to transmit the indication of the relative direction or the relative position of the second UE compared to the first UE, or store the indication of the relative direction of the second UE or the relative position compared to the first UE.

The means may be the multi-frequency ranging component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first user equipment (UE), comprising: measuring a set of phase difference of arrivals (PDoAs) for a set of radio links between the first UE and a second UE, wherein each radio link in the set of radio links is associated with a wavelength that is different from another radio link in the set of radio links, wherein the first UE includes at least two antennas with an antenna separation distance that is greater than or equal to a threshold; determining, based on the set of PDoAs for the set of radio links, a general function that is associated with a probability in which the second UE is at a set of relative directions or a set of relative positions compared to the first UE; and estimating, based on the determined general function, a relative direction or a relative position of the second UE compared to the first UE, wherein the relative direction is included in the set of relative directions and the relative position is included in the set of relative positions.

Aspect 2 is the method of aspect 1, wherein the general function corresponds to a loss function that is capable of determining a negative likelihood of a candidate angle-of-arrival (AoA) or a candidate position associated with the second UE.

Aspect 3 is the method of aspect 1 or aspect 2, wherein the set of relative directions corresponds to a set of angle-of-arrival (AoA) candidates, and wherein estimating, based on the determined general function, the relative direction of the second UE compared to the first UE comprises: determining an AoA candidate from the set of AoA candidates that optimizes the general function; and identifying the relative direction of the second UE based on the determined AoA candidate.

Aspect 4 is the method of any of aspects 1 to 3, wherein the set of relative positions corresponds to a set of three-dimensional (3D) coordinate candidates, and wherein estimating, based on the determined general function, the relative position of the second UE compared to the first UE comprises: determining a 3D coordinate candidate from the set of 3D coordinate candidates that optimizes the general function; and identifying the relative position of the second UE based on the determined 3D coordinate candidate.

Aspect 5 is the method of any of aspects 1 to 4, wherein measuring the set of PDoAs for the set of radio links between the first UE and the second UE comprises: receiving, from the second UE, a set of signals from each radio link in the set of radio links parallelly or consecutively; and measuring a PDoA for the set of signals from each radio link in the set of radio links to obtain the set of PDoAs for the set of radio links.

Aspect 6 is the method of any of aspects 1 to 5, further comprising: transmitting, to the second UE, a request to send the set of signals via at least two radio links with two or more frequencies, wherein reception of the set of signals from each radio link in the set of radio links parallelly or consecutively is based on the request.

Aspect 7 is the method of any of aspects 1 to 6, further comprising: initiating a ranging session with the second UE, wherein transmission of the request is based on the initiation of the ranging session.

Aspect 8 is the method of any of aspects 1 to 7, wherein the threshold is equal to λ/2 for at least one wavelength associated with each radio link in the set of radio links, λ being the wavelength associated with each radio link in the set of radio links.

Aspect 9 is the method of any of aspects 1 to 8, further comprising: determining a vector from a position of the first UE to a selected point in space; and converting the vector to a reference frame of the first UE, wherein the measurement of the set of PDoAs is based on the reference frame.

Aspect 10 is the method of any of aspects 1 to 9, wherein the reference frame corresponds to a set of spherical coordinates.

Aspect 11 is the method of any of aspects 1 to 10, further comprising: obtaining distance information between the first UE and the second UE; and determining, based on the distance information and the relative direction of the second UE, a second relative location of the second UE with respect to the first UE.

Aspect 12 is the method of any of aspects 1 to 11, further comprising: displaying, via a user interface (UI), the relative direction or the relative position of the second UE compared to the first UE.

Aspect 13 is the method of any of aspects 1 to 12, wherein displaying, via the UI, the relative direction or the relative position of the second UE compared to the first UE includes at least one of: displaying a direction of the second UE from the first UE, displaying a distance of the second UE from the first UE, or displaying an image or a description of the second UE.

Aspect 14 is the method of any of aspects 1 to 13, further comprising: outputting an indication of the relative direction or the relative position of the second UE compared to the first UE.

Aspect 15 is the method of any of aspects 1 to 14, wherein outputting the indication of the relative direction or the relative position of the second UE compared to the first UE comprises: transmitting the indication of the relative direction or the relative position of the second UE compared to the first UE; or storing the indication of the relative direction of the second UE or the relative position compared to the first UE.

Aspect 16 is an apparatus for wireless communication at a first user equipment (UE), including: at least one memory; and at least one processor coupled to the at least one memory and, based at least in part on stored information that is stored in the at least one memory, the at least one processor, individually or in any combination, is configured to implement any of aspects 1 to 15.

Aspect 17 is the apparatus of aspect 16, further including at least one transceiver coupled to the at least one processor.

Aspect 18 is an apparatus for wireless communication at a first user equipment (UE) including means for implementing any of aspects 1 to 15.

Aspect 19 is a computer-readable medium (e.g., a non-transitory computer-readable medium) storing computer executable code, where the code when executed by a processor causes the processor to implement any of aspects 1 to 15.

What is claimed is:

1. An apparatus for wireless communication at a first user equipment (UE), comprising:
at least one memory; and
at least one processor coupled to the at least one memory, the at least one processor, individually or in any combination, is configured to:
measure a set of phase difference of arrivals (PDoAs) for a set of radio links between the first UE and a second UE, wherein each radio link in the set of radio links is associated with a wavelength that is different from another radio link in the set of radio links, wherein the first UE includes at least two antennas with an antenna separation distance that is greater than or equal to a threshold;
determine, based on the set of PDoAs for the set of radio links, a general function that is associated with a probability in which the second UE is at a set of relative directions or a set of relative positions compared to the first UE; and
estimate, based on the determined general function, a relative direction or a relative position of the second UE compared to the first UE, wherein the relative direction is included in the set of relative directions and the relative position is included in the set of relative positions.

2. The apparatus of claim 1, wherein the general function corresponds to a loss function that is capable of determining a negative likelihood of a candidate angle-of-arrival (AoA) or a candidate position associated with the second UE.

3. The apparatus of claim 1, wherein the set of relative directions corresponds to a set of angle-of-arrival (AoA) candidates, and wherein to estimate, based on the determined general function, the relative direction of the second UE compared to the first UE, the at least one processor, individually or in any combination, is configured to:
determine an AoA candidate from the set of AoA candidates that optimizes the general function; and
identify the relative direction of the second UE based on the determined AoA candidate.

4. The apparatus of claim 1, wherein the set of relative positions corresponds to a set of three-dimensional (3D) coordinate candidates, and wherein to estimate, based on the determined general function, the relative position of the second UE compared to the first UE, the at least one processor, individually or in any combination, is configured to:
determine a 3D coordinate candidate from the set of 3D coordinate candidates that optimizes the general function; and
identify the relative position of the second UE based on the determined 3D coordinate candidate.

5. The apparatus of claim 1, wherein to measure the set of PDoAs for the set of radio links between the first UE and the second UE, the at least one processor, individually or in any combination, is configured to:
receive, from the second UE, a set of signals from each radio link in the set of radio links parallelly or consecutively; and
measure a PDoA for the set of signals from each radio link in the set of radio links to obtain the set of PDoAs for the set of radio links.

6. The apparatus of claim 5, wherein the at least one processor, individually or in any combination, is further configured to:
transmit, to the second UE, a request to send the set of signals via at least two radio links with two or more frequencies, wherein reception of the set of signals from each radio link in the set of radio links parallelly or consecutively is based on the request.

7. The apparatus of claim 6, wherein the at least one processor, individually or in any combination, is further configured to:
initiate a ranging session with the second UE, wherein transmission of the request is based on the initiation of the ranging session.

8. The apparatus of claim 1, wherein the threshold is equal to λ/2 for at least one wavelength associated with each radio link in the set of radio links, λ being the wavelength associated with each radio link in the set of radio links.

9. The apparatus of claim 1, wherein the at least one processor, individually or in any combination, is further configured to:
determine a vector from a position of the first UE to a selected point in space; and
convert the vector to a reference frame of the first UE, wherein the measurement of the set of PDoAs is based on the reference frame.

10. The apparatus of claim 9, wherein the reference frame corresponds to a set of spherical coordinates.

11. The apparatus of claim 1, wherein the at least one processor, individually or in any combination, is further configured to:
obtain distance information between the first UE and the second UE; and
determine, based on the distance information and the relative direction of the second UE, a second relative location of the second UE with respect to the first UE.

12. The apparatus of claim 1, wherein the at least one processor, individually or in any combination, is further configured to:
display, via a user interface (UI), the relative direction or the relative position of the second UE compared to the first UE.

13. The apparatus of claim 12, wherein to display, via the UI, the relative direction or the relative position of the second UE compared to the first UE, the at least one processor, individually or in any combination, is further configured to at least one of:
display a direction of the second UE from the first UE,
display a distance of the second UE from the first UE, or
display an image or a description of the second UE.

14. The apparatus of claim 1, wherein the at least one processor, individually or in any combination, is further configured to:
output an indication of the relative direction or the relative position of the second UE compared to the first UE.

15. The apparatus of claim 14, wherein to output the indication of the relative direction or the relative position of the second UE compared to the first UE, the at least one processor, individually or in any combination, is configured to:
transmit the indication of the relative direction or the relative position of the second UE compared to the first UE; or
store the indication of the relative direction of the second UE or the relative position compared to the first UE.

16. A method of wireless communication at a first user equipment (UE), comprising:
measuring a set of phase difference of arrivals (PDoAs) for a set of radio links between the first UE and a second UE, wherein each radio link in the set of radio links is associated with a wavelength that is different from another radio link in the set of radio links, wherein the first UE includes at least two antennas with an antenna separation distance that is greater than or equal to a threshold;
determining, based on the set of PDoAs for the set of radio links, a general function that is associated with a probability in which the second UE is at a set of relative directions or a set of relative positions compared to the first UE; and
estimating, based on the determined general function, a relative direction or a relative position of the second UE compared to the first UE, wherein the relative direction is included in the set of relative directions and the relative position is included in the set of relative positions.

17. The method of claim 16, wherein the set of relative directions corresponds to a set of angle-of-arrival (AoA) candidates, and wherein estimating, based on the determined general function, the relative direction of the second UE compared to the first UE comprises:
determining an AoA candidate from the set of AoA candidates that optimizes the general function; and
identifying the relative direction of the second UE based on the determined AoA candidate.

18. The method of claim 16, wherein measuring the set of PDoAs for the set of radio links between the first UE and the second UE comprises:
receiving, from the second UE, a set of signals from each radio link in the set of radio links parallelly or consecutively; and
measuring a PDoA for the set of signals from each radio link in the set of radio links to obtain the set of PDoAs for the set of radio links.

19. The method of claim 16, wherein the threshold is equal to λ/2 for at least one wavelength associated with each radio link in the set of radio links, λ being the wavelength associated with each radio link in the set of radio links.

20. A computer-readable medium storing computer executable code at a first user equipment (UE), the code when executed by at least one processor causes the at least one processor to:
measure a set of phase difference of arrivals (PDoAs) for a set of radio links between the first UE and a second UE, wherein each radio link in the set of radio links is associated with a wavelength that is different from another radio link in the set of radio links, wherein the first UE includes at least two antennas with an antenna separation distance that is greater than or equal to a threshold;
determine, based on the set of PDoAs for the set of radio links, a general function that is associated with a probability in which the second UE is at a set of relative directions or a set of relative positions compared to the first UE; and
estimate, based on the determined general function, a relative direction or a relative position of the second UE compared to the first UE, wherein the relative direction is included in the set of relative directions and the relative position is included in the set of relative positions.
